(19) United States
(12) Patent Application Publication
(10) Pub. No.: US 2016/0050477 A1
(43) Pub. Date: Feb. 18, 2016

(54) IN-THE-EAR EARPHONE, (ITS VARIANTIONS) AND METHODS OF WEARING

(71) Applicant: Alexey Leonidovich Ushakov, MOSCOW (RU)

(72) Inventor: Alexey Leonidovich Ushakov, MOSCOW (RU)

(21) Appl. No.: 14/632,459

(22) Filed: Feb. 26, 2015

(30) Foreign Application Priority Data
Aug. 15, 2014 (RU) RU2014133659

(51) Int. Cl. H04R 1/10

(52) U.S. Cl. CPC H04R 1/105

(57) ABSTRACT

The present invention relates to the field of acoustics, in particular to earphones, and more particularly to an adjustable in ear earphones. Proposed in-the-ear earphone to be worn in two positions, comprising: an acoustic part comprising at least one electroacoustic transducer and at least one sound opening designed to output an acoustic signal generated by the electroacoustic transducer, a wire, electrically connected with said electroacoustic transducer, a mechanical part, connected with said acoustic part through a cylindrical hinge and having a shaft designed to be rotatable, the resilient element, connected to one end of said shaft, a guide wire connected to the opposite end of said shaft, wherein, said resilient member and the guide are located at its greater part in the same plane with the axis of rotation of the shaft and oriented substantially in opposite directions from the axis of rotation of the shaft; wherein said sound opening is located at the end of the acoustic part, opposing cylindrical hinge; said end portion of acoustic part is designed in such a way as to exclude the possibility of clogging the sound opening when wearing in any of said positions; said cylindrical hinge is designed in such a way to permit rotation of said shaft by an angle α, which is at least 70 degrees from the position wherein said guide is oriented towards the sound opening; said wire is mechanically connected with said guide. The technical result of expansion of the arsenal of in-the-ear earphones is having the ability to be worn in two positions.

### FIELD OF THE INVENTION

The present invention relates to the field of acoustics, in particular to earphones, and more particularly to an adjustable in ear earphones.

### BACKGROUND OF THE RELATED ART

Earphones placed inside the ear, according to the type of embodiment are divided into two types:
earbuds or plug-in earphones;
in-ear-canalphones or IEMs (In-Ear-Monitors).

Earbuds (inserted)—earphones inserted into the ear and held there by the resilience force. Earphones of this type are not completely plug the external auditory canal and placed next to it directing the sound waves in the direction of the external auditory canal. The disadvantages of this type of earphone may include:
poor sound insulation from ambient noise;
due to the fact that they do not completely cover the external auditory canal, audio quality is significantly degraded;
weakly bonded inside the ear if not provided with additional devices to hold.

But earbuds have certain advantages: they do not irritate the pressure-sensitive surface of the membranous-cartilaginous (front) of the external auditory canal and allow hearing surrounding sounds.

In-ear-canalphones (various sources also called vacuum earphones, plugs, ear monitors, in English sources as IEMs)—worn completely plug the ear canal, providing good insulation against ambient noise.

Compared with earbuds they have a number of tangible advantages:
provide high-quality sound;
in-ear-canalphones—IEM are relatively well stay in the ear since they are quite tightly and deeply enter into the external auditory canal.

The disadvantages of this type of earphones should include:
unpleasant and painful sensations during long-term wear, since they are strongly pressure on the most sensitive area of the outer ear—the front part of the membranous-cartilaginous portion of the external auditory canal;
ear opening is earphone plugged and consequently it is difficult to outflow from the sebaceous and sulfur glands located in the membranous-cartilaginous portion of the external auditory canal;
due to the relatively good passive noise-isolation hearing of ambient sounds is difficult;
increases the load on the hearing aid during prolonged listening at high volume levels that can cause hearing loss.

In some constructive solutions earbuds supplied with directed into the ear canal pin with soft sealing ear cushion. This increases the useful volume of the earphones through the use of internal volume of the ear, not just the ear canal. However, like earphones have all the disadvantages of in-ear-canalphones.

Known custom headset for placement in the ear (US Application Publication No 2011/0135120 A1), which consists of a housing containing a near and remote part, where a remote part has a built-in speaker and it is formed for accommodation in the ear canal of the user, also a remote part includes a projection for its seal in the ear canal. This headset has no moving parts, thus does not give an opportunity to adjust the earpiece in the ear of the user, and not combines the features of in-ear-canalphones and earbuds.

Known earphone (U.S. Pat. No. 8,265,328), which consists of the ear hook, shaft attached to the end of the ear hook, housing for electro-acoustic transducer, tube allowing the body to move along the shaft, and also includes a cable connected to the electroacoustic transducer and extending inside the ear hook, shaft and housing. This earphone design allows a minor adjustment of the position of the earphone inside the ear, but only earbuds can be used. Despite the fact that the sliding of the shaft is provided in the tube attached to the earpiece, movement is only possible in the longitudinal axis direction, without rotation. This earphone rather cumbersome, hook-shaped, which may lead to the engagement of the clothes or wire during inoperative state, as well as complicates the use of the earphones in conjunction with other equipment, such as goggles, helmets etc.

Known ear loop for earphone (U.S. Pat. No. 8,320,603). Like the previously considered earphones this one has a shaft inserted in the ear hook tube that enables adjustment of the earphone inside the ear. This design has the same disadvantages as the previous earphone, and itself earphone is a plug-in with some characteristics of a particular type of earphone, which excludes its transformation into intra-canal.

Known earphone adapter (U.S. Pat. No. 8,472,660), intended for earbuds and comprising BTE (Behind The Ear) earhook with the option of movable placement of earphone on it, allowing adjustment of earphone. The disadvantages of this adapter is the fact that only earbuds can be used, since the mobility of the earphone on the earhook axis doesn't allow placement of the earphone in intra-cannel position, i.e. transform earphone from the earbud into in-ear-canalphones. In addition, when wearing earhook covers the ear from the outside almost completely, due to which the entire structure is large and has pronounced hook shape, thus this adapter inherent disadvantages of the two previously considered devices.

Known earbud type of earphone having auricular fastening (U.S. Pat. No. 5,729,615) with the rod rigidly attached to the earphone acoustic elements, where the rod entering into the bushing, continuation of which is a BTE earhook of earphone. Acoustic element can be rotated relative to the bushing-earhook and vertically lifting or lowering by sliding the rod inside the bushing. The disadvantage is a limited number of adjustments intended for selecting only one relatively comfortable position acoustic element in the auricle when using earphones for different people with different anthropometric data. Moreover, an integral fixture of this type of earphone is massive BTE earhook, increasing the size, complicates form and increased number of clinging hook-shaped members in the earphone.

Known a device of the earphones with stabilizer (U.S. Pat. No. 8,374,375), which comprises a housing and a flexible member to stabilize the earphone when wearing by abutting the wall of the ear, wherein flexible element has two stable positions relative to the housing and respectively earphone can have two positions in the auricle. But in this device change in position of earphone in the ear does not lead to the possibility of its transformation from earbud into in-ear-canalphones.

Known acoustic device with the adaptation for placement in a human ear (U.S. Pat. No. 7,068,803), which is an earphone with a spring in the form of a flexible rod, which holds the earphone in the ear of the user, located in the bent state along the wall of the ear. This device provides secure fit of the earphone in the auricle in the only position, not allowing adjustment of the earphone or its transformation.

Known hearing aid with a flexible elongate member (U.S. Pat. No. 8,374,367), made in the form of earbuds, containing a microphone, processor, headset, battery and a flexible elongated portion, one end of which is attached to the housing, the other is free, wherein when the flexible elongate portion is placed in the user auricle, the free end is located inside the auricle and outside the ear canal. As with the previous device a hearing aid is retained in the auricle due to the resilience of the elongated member that enables to secure the unit in the only position.

Known retaining element for micro-earphone for use in hearing aids (U.S. Pat. No. 7,590,255), having in-ear-canalphones type provided with elongate resilient member for support on the internal parts of the auricle, where the aggregate resilience of the tissues of the auricle and said elongate member promotes fixation of the earbud in the ear canal, preventing its loss during wear. This element is designed only for hearing aids and also provides for the use of earphone in the only position eliminating the possibility of transformation earphone from in-ear-canalphones into earbuds.

Known universal hearing aid (U.S. Pat. No. 7,899,200), also comprising an elongated resilient part to fix the earphone in the user auricle. This unit has inherent disadvantages of the two previously considered devices.

The general disadvantage of the most of the considered earphone devices can also be attributed use of design solutions ear cushions made of soft material (rubber, foam, rubber foam) for adaptation and fitting of earphone in the ear canal of the user. But soft materials easily become contaminated with dust or earwax, poorly cleaned and therefore can easily become unhygienic.

Thus, to date there are not created in the ear earphones allows full use of the benefits of design solutions for earbuds and in-ear-canalphones—IEM (In Ear Monitor) depending on current requirements of the user when worn.

### Justification of the Proposed Structural Embodiment of Earphones.

When wearing earbuds user may experience some difficulties when they loosely inserted into the auditory canal as earphones spontaneously fall out of the ear. Some manufacturers try to solve this objective placing on the earpiece extra soft and flexible stops (soft springs), abutting against the antihelix or lower leg of the antihelix, but in order that said devices would not irritate or pressure sensitive parts of the ear is required to select the least sensitive parts of the ear which will be pressured by resilient elements of the earphone and distribute the pressure over a larger area. As an example, consider two options of chuckles of the glasses—the so-called “children's” glasses with semi-rounded spring temples resiliently covering the conchae from outside and the rear—this option presented in cheaper models of glasses and long wearing often causes discomfort, as conchae is very sensitive in these points of contact with temples, as on inside or outside (although within short-term use discomfort could be not even noticed). Expensive glasses are held with minimal discomfort without squeezing the ear only because temples resiliently semi-covering human skull, as places of semi-coverage on the skull having much less tactile sensitivity.

When designing earphones for permanent (long-term) use should be considered structure, innervation and blood supply to the concha of human ear, so as not to cause long-term irritation and oppressive effects on the most sensitive areas of the ear.

Blood supply to the ear is carried out through the posterior auricular artery, the superficial temporal artery and branches of the internal maxillary artery. Blood from the auricle enters the superficial temporal and posterior auricular veins that usually go along with the arteries.

Innervation of the auricle is carried out by a great auricular nerve, small occipital nerve, trigeminal nerve, nerve endings mixed branches of the vagus, glossopharyngeal and facial nerves.

Thus, a detailed study of schemes nerves and blood vessels with a high degree of probability, the least sensitive to prolonged tactile mechanical stress is portion the auricle at the junction of the ear cavity to the back side of anti-tragus. It is in the lower part of the ear cavity should be centered the main body weight of the earphone placed in the auricle with a valid negligible impact on the tragus—lower part of the antihelix (front-back), and the inside of the anti-tragus—ear cavity (laterally).

The second support point (from which comes out the earphone wire) may be the edge of the temporal bone, slightly above and over the tragus hump, already outside the auricle. This place is the least sensitive because it is no longer the auricle, here is an extensive insensitive connective tissue zone—ligamentum auriculare anterius (ligament of the auricle front), and all the nerves and arteries pass under this ligament, and therefore the surface of the ligamentum auriculare anterius is insensitive to the prolonged pressure.

We offer new constructive solution for earphone illustrated in FIGS. 1, 2, which comprising of: acoustic part 1 with electro-acoustic transducer 2 and sound opening 3, wire 4 and mechanical part 5 with a cylindrical hinge 6, shaft 7, an resilient member 8 and guide wire 9. The cylindrical hinge is made rigidly rotating or earphone further comprises a return mechanism shaft. FIG. 1 shows an embodiment with a rigidly rotating hinge.

Earphone design includes their use by the user in two positions. In position “quality” most of the earphone is placed inside the user's auditory canal, sound opening 3 is deep within the auditory canal, and the earphone housing is maximum circumferentially adjacent to the walls of the external auditory canal and clogs it. In the “comfort” position earphone placed in the auricle without inside penetration of the user's auditory canal, and the sound opening 3 is located near the entrance to the auditory canal. Necessary to provide a reliable fastening of earphones when worn by the user in both positions.

The proposed design of the headset includes an elastic element 8 in the form of a resilient rod of rounded or polygonal section, which is a continuation of the earphone rotary shaft 7 and is rigidly attached at one end at its lower part. Element purpose is in fixing the earphone in auricle, which is especially important in the headset wearing mode “comfort”. The prior art discloses the resilient elements used as a spring spacers between the headset, set in the external auditory meatus, and antihelix wall, and fixing the earphone housing in the auricle by forces directed forwards the tragus and back toward the anti-tragus (e.g., an resilient element is known from U.S. Pat. No. 7,068,803). But in this case, fastening the earphone is only achieved by narrowly directed effect of two bursting forces pressing earphone housing to tragus and the end of the resilient element to the anti-tragus. Such a local area of application of force can cause pain and is not conducive for long wearing of earphones.

In the present application the earphone resilient member has a much greater length and when placing earphone in the auricle resilient member is directed substantially upwards, causing it to bend, having a smaller than the shorter resilient elements curvature radius r. Moment of resilient forces M at bending point is defined as: M=EJ/r, where E—Young's modulus, J—cross-section moment of inertia. The formula shows that by using a more flexible materials by increasing the length of the flexible member and as a consequence, reducing the radius of curvature r, possible to create sufficient to secure the earphone moment M, and more resilient materials when bending deformation make efficient use of the element compression for redistribution of the fixing force over the entire length of the element. For this purpose necessary to lean the most part of the surface of convex arched resilient element to the upper inner wall of the antihelix. FIG. 3 illustrates an earphone in the ear in the “comfort” position displaying the vectors of deformation force. These forces and deformation \vec{R} and \vec{R}₀, compressing the arc of the resilient member, will be directed not only forward to the tragus but also have a vertical projection. These forces have a large application area and distribute the pressure along the lower surface of the headset on the area at the lower part of the cavity of the auricle (area R₀ is shown by shading) and along the inner wall of the antihelix (area R is shown by shading), which, in turn, will contribute to lower the pressure force per unit area, which leads to a reduction in discomfort when wearing.

An additional factor that serves to secure the headset can serve a frictional force that occurs along the entire length of the resilient member.

FIG. 4 shows a top view of the earphone, placed in user's ear (given in section) in the “quality” position displaying vectors of forces affecting the earpiece. Return mechanism 21 of cylindrical hinge seeking to return the rotating shaft to a position when the guide 9 is directed towards the sound opening 3, together with deformable resilient member 8 results in a force \vec{R}, which abuts the resilient member 9 to the inner surface of the anti-tragus and a force \vec{R}₀, which guide the earphone housing to abut the front wall of the ear canal.

In the upper part of design of our earphone the guide for wire 9 in conjunction with the curved upper part of the shaft 7 form a semi-earhook. The use of this constructive solution allows further secure the earpiece in the ear. At the output of the earphone housing the upper part of the shaft 7 is bent sufficiently, to perform as a lever with point of support at the front ligament of the auricle (FIG. 5a). During wearing the headset by the user when the wire goes around the top of the auricle, when wire is pulled (force \vec{T}), a moment of tension force M_{T} turns earphone towards the auricle canal, improving fastening of earphone in the auricle.

These conditions are optimally performed in stereo headset, having in its composition suboccipital unit (RU patent number 2,520,184). When using earphones in the composition of said stereo headset, vector sum of the forces affecting the earphones of said structure when worn further secures them into the ear.

In the “comfort” resilient cartilage of the auricle tends to push the earphone out. The ejection force is applied perpendicular to the axis of rotation of the cylindrical joint, which leads to its rotation and loss of earphone. To counteract this force is effective the use of the return mechanism shaft. 5a and 5b are views from above and behind (ear given in section) on the headset in the “comfort” position with an indication of the vector diagram of projections forces. Force \vec{Q_{N}} (FIG. 5a) pushes the headset from the ear. It balanced by the forces of interaction of the earphone housing with the shaft \vec{N} and \vec{N}₁. Return mechanism creates a force couple \vec{F_{c}} and \vec{F_{c}′} or torque \vec{M_{c}}, which compensates for torque \vec{Q_{N}} relative to the axis of the shaft. Along the horizontal forces earphone is affected by vertical force, diagram of which is shown in FIG. 5b. Force \vec{P}—vertical pressure force on the earpiece. It includes earphone gravity, the vertical component of the pressure force of the deformed elastic member, the force transmitted to the bent portion of the shaft of the tension wire (\vec{T}—wire tension force) coming from the earpiece. Wire tension force \vec{T} using suboccipital unit is oriented not only up, but also slightly medially. Force \vec{N} and \vec{N}₁ forces of shaft reaction. Force \vec{Q} arises from the resilience of tissue of the auricle from pressure of earphone; it is perpendicular to the axis of the cylindrical joint and tends to push the earphone from of the auricle. Force \vec{Q} has a vertical component \vec{Qₚ}, compensating force \vec{P} and horizontal component \vec{Q_{N}}, compensating force \vec{N} and \vec{N}₁.

### SUMMARY OF INVENTION

The object of the present invention to provide earphones having advantages of earbuds and simultaneously in-ear-canalphones, but without the drawbacks inherent to each type, that is, the earphones should be securely kept in-ear during wear, but their position could be changed, that is, the earphones must have two fixed positions; first position—intra-channel, second position—in the auricle without taking the entire ear canal and allowing the user to hear surrounding sounds. Such earphones allow, depending on the environment and requirements of the user, provide passive noise reduction or control the sound environment around user.

Problem is solved by creating an in-ear earphone to be worn in two positions, containing acoustic portion, which includes at least one electroacoustic transducer and at least one sound opening for the acoustic output signal, also earphone comprises a wire electrically connected to said electroacoustic transducer, mechanical part connected to said acoustic part through the cylindrical hinge and having a rotatable shaft, a resilient member connected to one end of said shaft, a guide wire connected to an opposite end of said shaft, wherein, said resilient member and the guide are located at its greater part in the same plane with the axis of the rotation of the shaft and oriented substantially in opposite directions from the axis of rotation of the shaft, wherein said sound opening is located at the end of the acoustic part, opposing cylindrical hinge, said end portion of acoustic part is designed in such a way to exclude the possibility of clogging the sound opening when wearing in any of said positions, said cylindrical hinge is designed in such a way to permit rotation of said shaft by an angle α, which is at least 70 degrees from the position wherein said guide is oriented towards the sound opening, said wire is mechanically connected with said guide.

Preferably, that said guide had a length such that when worn in any of these two provisions said guide was housed in the upper clipping of the auricle between the leg curl and upper-tragus tubercle, while place of connection of the wires and said guide was located on the surface of the front ligaments of the auricle, and wire rounded the ear at the top, said acoustic part was made in such a form that when worn in one of said positions, corresponding rotation of the shaft at an angle α=70-90 degrees, said acoustic part at least partially was housed inside the outer auditory canal of user, wherein the sound opening is deepened into the external auditory canal, a resilient member located within the cavity of the auricle behind the anti-tragus, and thus may serve to extract the earphone of the external auditory canal, said acoustic part while wearing in the other said position corresponding to the orientation of the guide towards the sound opening, located in the cavity of the auricle between the tragus and anti-tragus, sound opening located in the vicinity of the entrance of the external auditory canal, a resilient element abuts the lower leg of the antihelix and thus serves to keep the headset in the ear.

Useful that earphone further comprises a protective grille, designed to protect from clogging the sound opening.

Advisable that at least one end of said shaft was executed as curved relative to the axis of rotation of the shaft.

Useful that both ends of said shaft are made curved in opposite directions from the axis of rotation of the shaft.

Advisable that earphone further comprises a return mechanism that returns the shaft to a position wherein said guide is oriented towards the sound opening, and the angle alpha is close to or equal to 0.

It is useful that said return mechanism has been designed as a cylindrical helical spring wound around the shaft freely, wherein one end of the spring is attached to the acoustic part portion and the other end of the spring is attached to the one the ends of said shaft.

It is useful that the return mechanism has been designed as a bending spring, one end of which is attached to one end of the shaft and the other end is attached to the acoustic part of the earphone.

Preferably, that the cylindrical hinge further comprises at least one sleeve, in which is located said shaft.

Advisable that mechanical part was arranged pivotable of said shaft by an angle α in the range of 70 to 90 degrees in any direction from the position wherein the guide is oriented in the direction of said sound opening.

It is useful that the earphone has been adapted to be worn in either ear of the user.

Advisable that said wire at the section between the fastening places of the wire to the guide and to the acoustic transducer has additional slack to allow rotation of the shaft.

Useful that said shaft and said resilient member are made hollow, wire was placed inside the shaft and the elastic member and further was mechanically fastened to the lower end of the shaft, forming a loop, and the portion of wire between places of additional fastening of wires to the lower end of the shaft and to the electroacoustic transducer had an extra slack.

Useful that said wire further comprises an electrical connector on the section between the fastening places to the upper part of the shaft and to the acoustic transducer.

Preferably, that said shaft has been adapted for longitudinal movement within said cylindrical hinge. Also useful, that in addition the earpiece comprises a cylindrical helical compression spring, wounded around the shaft between the guide and acoustic part.

Advisable that portion of said wire disposed between the guide and acoustic part was formed as a cylindrical helical compression spring wounded around the shaft.

Useful the guide and said shaft are made hollow, wire was located inside said cavity, and a cylindrical hinge further comprises brush-commutator assembly, adapted for electrical connection of said wires with the electroacoustic transducer.

Advisable that the headset further comprises a embouchure, and said acoustic part was additionally equipped with mounts for him.

Useful that the earphone further comprises soft case designed to fit over the acoustic part of the earphone, wherein said cover has at least one opening, serving for audio output and located opposite said sound opening when wearing the cover.

Preferably, the resilient element was made removable.

It is useful that the resilient member further comprises a longitudinal rigid thread secured inside the resilient member.

Advisable that resilient element is adapted to adjust its length.

It is useful that the resilient element is formed as a loop.

It is useful that the earphone further comprises at least one retainer adapted to hold the shaft in at least one of said positions.

Advisable that earphone further comprises at least one microphone.

It is useful that the earphone further comprises a bone conduction microphone.

Also, the task set is solved by creating an in-earphone to be worn in two positions, containing the acoustic part comprising at least one acoustic transducer and at least one sound opening, designed to output an acoustic signal generated by the electroacoustic transducer, also includes earphone wire, electrically connected to said electroacoustic transducer, mechanical part connected to said acoustic part through the cylindrical hinge and comprising a rotatable shaft, a resilient member connected to one end of said shaft, a guide wire, coupled to an opposite end of said shaft, wherein, said resilient member and the guide having its large part in one plane with the axis of shaft rotation, and are oriented essentially in opposite directions from the axis of shaft rotation, wherein said sound opening is located at the end of acoustic part, opposing cylindrical hinge, said end of acoustic part configured so as to prevent clogging of the sound opening during wearing in any of said positions, said cylindrical hinge is formed so as to allow rotation of said shaft by an angle α, which is at least 70 degrees from a position wherein said guide is oriented towards the sound opening, said wire is mechanically connected to said guide, wherein, said guide has a length such that when worn in any of these two positions, said guide is placed at the top of the auricle clipping between leg curl and upper-tragus tubercle, and the place of connection wire and said guide located on the surface of the front ligament of the auricle, and the wire goes around the ear from the top, said acoustic part is shaped so that when worn in one of said positions corresponding to the shaft rotation at an angle α 70÷90 degrees, said acoustic part at least partially housed within the user's outer auditory canal, wherein the sound outlet is recessed into the external auditory canal, a resilient member located in the cavity of the auricle behind anti-tragus and thus can serve to extract the earphone from the external auditory canal, acoustic part when wearing the headset by the user in the other above-mentioned position, corresponding to orientation of the guide in the direction of the sound opening, located in the cavity of the auricle between the tragus and anti-tragus, the sound outlet is located at the same time in the vicinity of the entrance of the external auditory canal, and a resilient element abuts the lower leg of antihelix and thus serves to keep the earpiece in ear.

Useful that earphone further comprises a protective grille, designed for protection against clogging of the sound outlet when worn.

Advisable that at least one end of said shaft has been executed curved with respect to the axis of rotation of the shaft.

It is useful that both ends of said shaft are made curved in opposite directions from the axis of rotation of shaft.

It is useful that the earphone further comprises a return mechanism which returns the shaft to a position wherein said guide is oriented towards the sound opening, and the angle alpha is close to or equal to 0.

Advisable that said return mechanism is configured as a helical cylindrical spring loosely wound around the shaft, wherein one end of the spring is attached to the acoustic part and the other end of the spring is attached to one end of said shaft.

It is useful that the return mechanism has been designed as a bending spring, one end of which is attached to one end of the shaft and the other end is attached to the acoustic part of the earphone.

Advisable that earphone further comprises at least one retainer adapted to hold the shaft, at least in one of said positions.

It is useful that the mechanical part was designed pivotable on said shaft at the angle α in the range of 70 to 90 degrees in any direction from a position in which said guide is directed toward said sound opening.

Advisable that earphone has been configured to be worn any user's ear.

Useful to said wire in the area between the place of wire attachment to the guide and to the acoustic transducer has additional slack to allow rotation of the shaft.

Advisable that shaft and a resilient member are made hollow, wire was placed inside the shaft and the resilient member and further mechanically fastened to the lower end of the shaft, forming a loop, and the portion of wire between places of additional fastening of wire to the lower end of the shaft and to the electroacoustic transducer had an extra slack.

It is useful that said wire further comprises an electrical connector on the section between places of attachment to the upper part of the shaft and to the acoustic transducer.

It is advisable that said shaft has been adapted to move longitudinally in said cylindrical hinge.

It is useful that earphone further comprises a cylindrical helical compression spring wound around the shaft between the guide and acoustic part.

Advisable that portion of said wire situated between the guide and acoustic part was formed as a cylindrical helical compression spring wound around the shaft.

It is useful that the guide and said shaft were made hollow; wire was located inside said cavities, where cylindrical hinge further comprises brush-collecting assembly adapted to be electrically connected of said wire with the electroacoustic transducer.

Advisable that earphone further comprises a embouchure, and said acoustic part was additionally equipped with its mounts.

Useful that earphone further comprises soft case designed to fit over the acoustic part of the earphone, wherein said case has at least one opening serving for the sound outlet and located opposite said sound opening when wearing the case.

Preferably, that the resilient element was made removable.

Advisable that resilient element further comprises a longitudinal rigid thread secured inside the resilient member.

It is useful that the resilient element is adapted to adjust its length.

Advisable that resilient element was formed as a loop.

It is useful that cylindrical hinge further comprises at least one sleeve.

Advisable that earphone further comprises at least one microphone.

It is useful that the earphone further comprises a bone conduction microphone.

Also, the task set is solved by providing a method of wearing the in-ear-canalphones comprising an acoustic part having at least one electro-acoustic transducer and at least one sound opening for the acoustic signal output, generated by electro-acoustic transducer also a headset comprises a wire electrically coupled to said electro-acoustic transducer, a mechanical portion connected to said acoustic part through a cylindrical hinge and comprising a rotatable shaft, a resilient member connected to one end of said shaft, a guide wire connected to an opposite end of said shaft, wherein, said resilient member and the guide located at its large parts in one plane with the axis of rotation of shaft, and oriented essentially in opposite directions from the axis of rotation of shaft, wherein said sound opening is located at the end of acoustic part, opposing to cylindrical hinge, said end of acoustic part configured so as to prevent clogging of the sound outlet during wearing in any of said positions, said cylindrical hinge is formed so as to allow rotation of said shaft by an angle α, which is at least 70 degrees from a position wherein said guide is oriented towards the sound opening, and said wire is mechanically connected to said guide, wherein, for arranging the sound opening inside of the external auditory canal, the user turns the shaft at an angle α, which is at least 70 degrees from a position wherein said guide is oriented towards the sound opening, arranges acoustic part inside of the external auditory openings, wherein a user places the resilient member in the cavity of the auricle behind anti-tragus, as for arranging the sound opening on the outside from the entrance of the external auditory canal, a user rotates the shaft to a position where the upper part of the shaft directed towards the acoustical opening, arranges acoustic part in the cavity of the auricle between the tragus and anti-tragus, a resilient member in the in the cavity of the auricle behind the anti-tragus, wherein, when worn in any of said two positions, the user places said guide wire at the top clipping of the ear auricle between the leg curl and the upper-tragus tubercle, place of connection of wire and said guide on the surface of the front ligament of the auricle, and wire from the top of the auricle.

### BRIEF DESCRIPTION OF THE DRAWINGS

The invention is further explained by description of preferred embodiments with reference to the accompanying drawings, in which:

FIG. 1 is a perspective view of the earphone according to the invention;

FIG. 2 shows a sectional view of the earphone in one embodiment showing the main functional elements of the invention;

FIG. 3 shows the earphone in the ear in the “comfort” position displaying the force vectors of the present invention;

FIG. 4 shows the earphone in the ear in the “quality” position displaying the force vectors of the present invention;

FIG. 5a and FIG. 5b show a rear and top view on the earphone in the “comfort” position displaying vector diagram of the projections of forces, according to the invention;

FIG. 6 and FIG. 7 show two ways of wearing the earphone by user, according to the invention;

FIG. 8 and FIG. 9 show the relative positions of earphone parts while wearing earphone in two positions, according to the invention;

FIG. 10 and FIG. 11 show shaft embodiments according to the invention;

FIG. 12 shows the earphone further comprising a spring according to the invention;

FIG. 13 and FIG. 14 show embodiments of the earphone, comprising a sleeve according to the invention;

FIG. 15 and FIG. 16 show embodiments of the earphone for use in any user's ear, according to the invention;

FIG. 17 and FIG. 18 show embodiments of the earphone with wire forming a loop according to the invention;

FIG. 19 and FIG. 20 show different embodiments of the earphone with the possibility of longitudinal shaft movement according to the invention;

FIG. 21 shows the earphone comprising a brush-collector mechanism according to the invention;

FIG. 22 shows the earphone comprising embouchure according to the invention;

FIG. 23 and FIG. 24 show embodiments of the flexible element according to the invention;

FIG. 25 shows the earphone comprising microphones according to the invention;

FIG. 26 shows the earphone in a simple implementation of the invention;

FIG. 27, FIG. 28 and FIG. 29 show the earphone in one embodiment of the invention.

### DESCRIPTION OF THE PREFERRED EMBODIMENT

The terms and expressions used in this text, give the following meaning, which may differ from generally accepted meanings.

In-ear the earphone—a device for personal listening to music, speech or other audio signals adapted to be located within the outer ear of the user.

Electroacoustic transducer—electromagnetic energy wave converter into acoustic wave (dynamic or reinforcing acoustic emitter).

Wire—linear flexible electric conductors, containing one or more twisted or adjacent, isolated or non-isolated interconnected conductors, wires or individual cables, with the insulation over them or without insulation.

Terms such as “front”, “rear”, “right”, “left”, “upper”, “lower” and their derivatives represent the position of parts of the earphone or earphone itself, taken with respect to the user's head, being in an upright position and looking straight and forward.

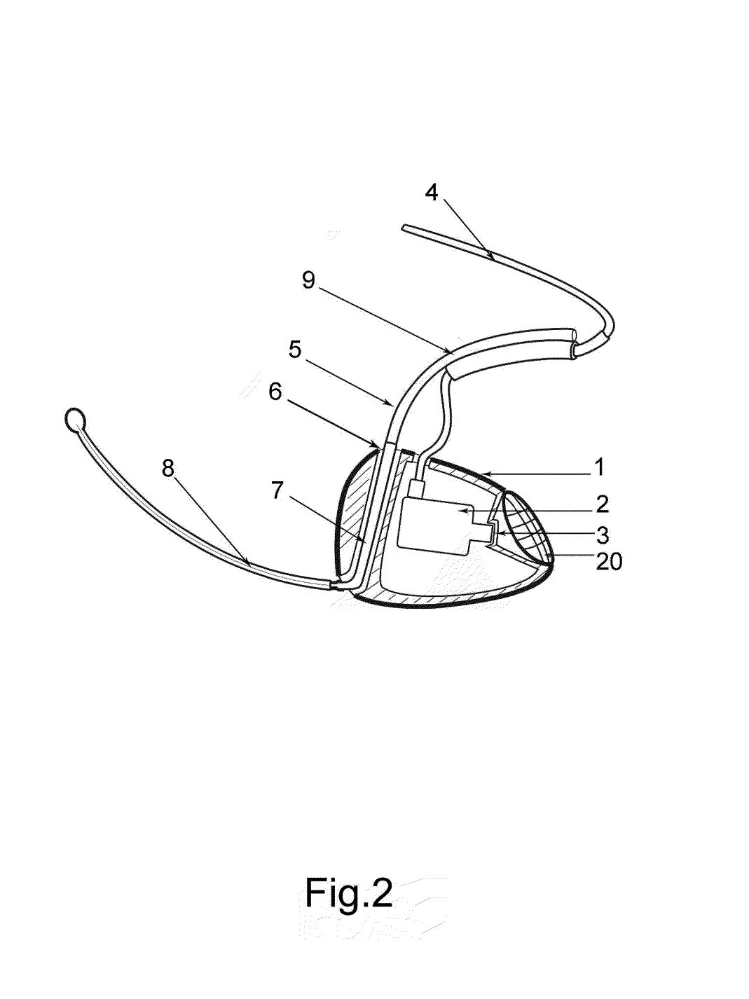

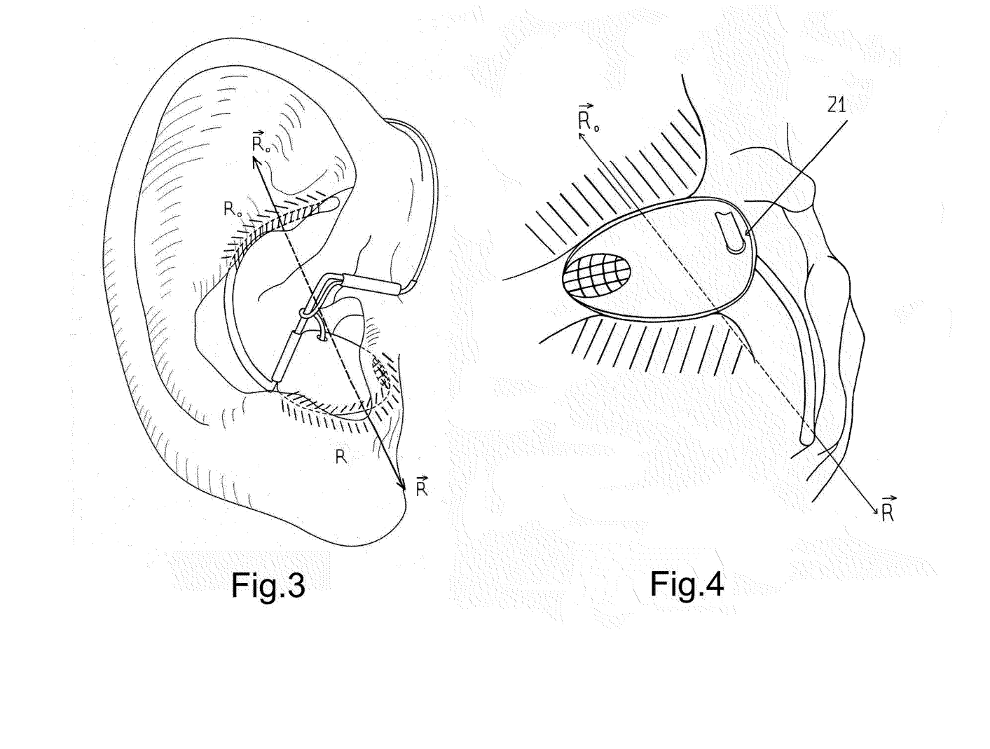

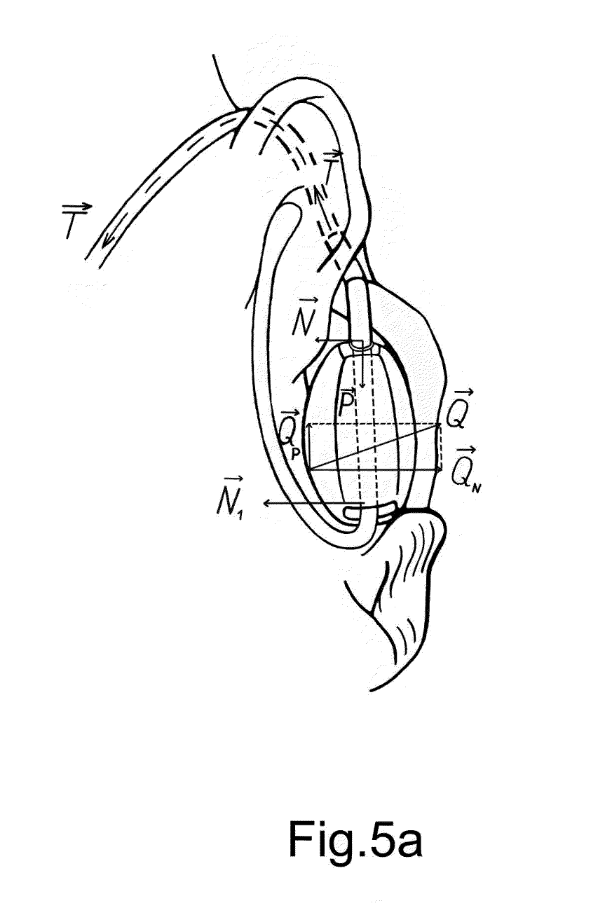

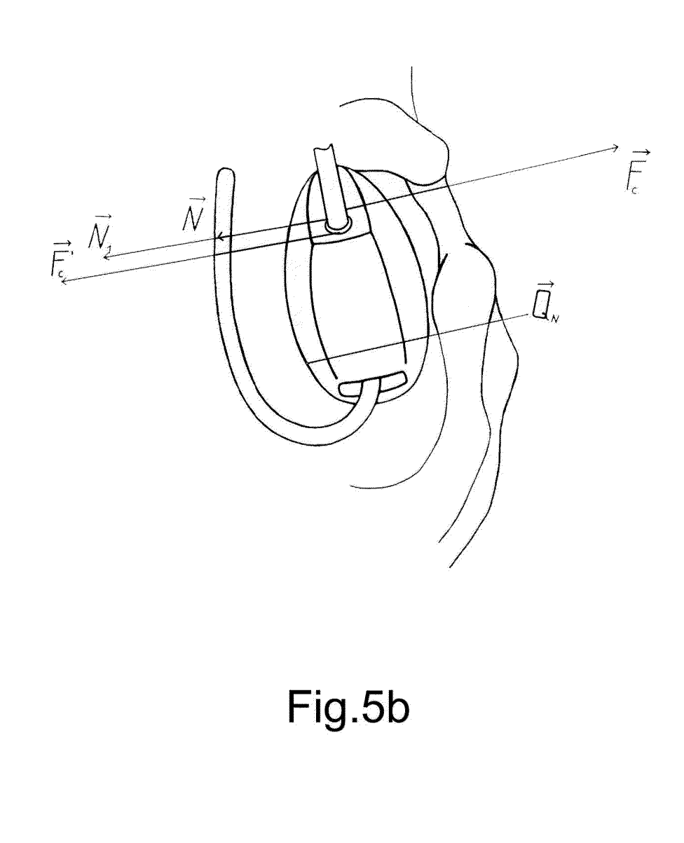

An in-the-ear earphone (FIG. 2) to be worn in two positions comprises acoustic part 1, comprising at least one electroacoustic transducer 2, and at least one sound opening 3, intended for an acoustic output signal, generated by electro-acoustic transducer, further, an in-the-ear earphone comprises wire 4, electrically connected to said electroacoustic transducer 2, mechanical part 5 coupled to said acoustic part 1 by means of a cylindrical hinge 6, and comprising rotatable shaft 7, the resilient member 8 connected to one end of said shaft, guide wires 9 connected to the opposite end of said shaft, wherein, said resilient member 8 and the guide 9 having its large part in one plane with the axis of shaft rotation, and are oriented essentially in opposite directions from the axis of shaft rotation, wherein said sound opening 3 is located at the end of acoustic part, opposing cylindrical hinge 6, said end of acoustic part configured so as to prevent clogging of the sound opening during wearing in any of said positions, said cylindrical hinge 6 is formed so as to allow rotation of said shaft 7 by an angle α, which is at least 70 degrees from a position wherein said guide 9 is oriented towards the sound opening 3, said wire 4 is mechanically connected to said guide 9.

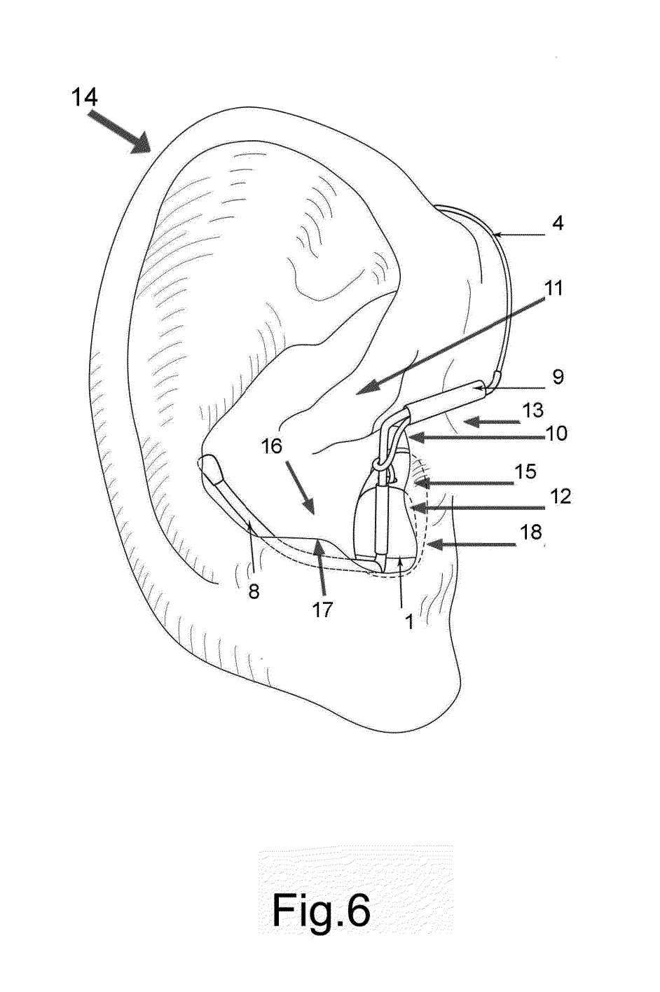

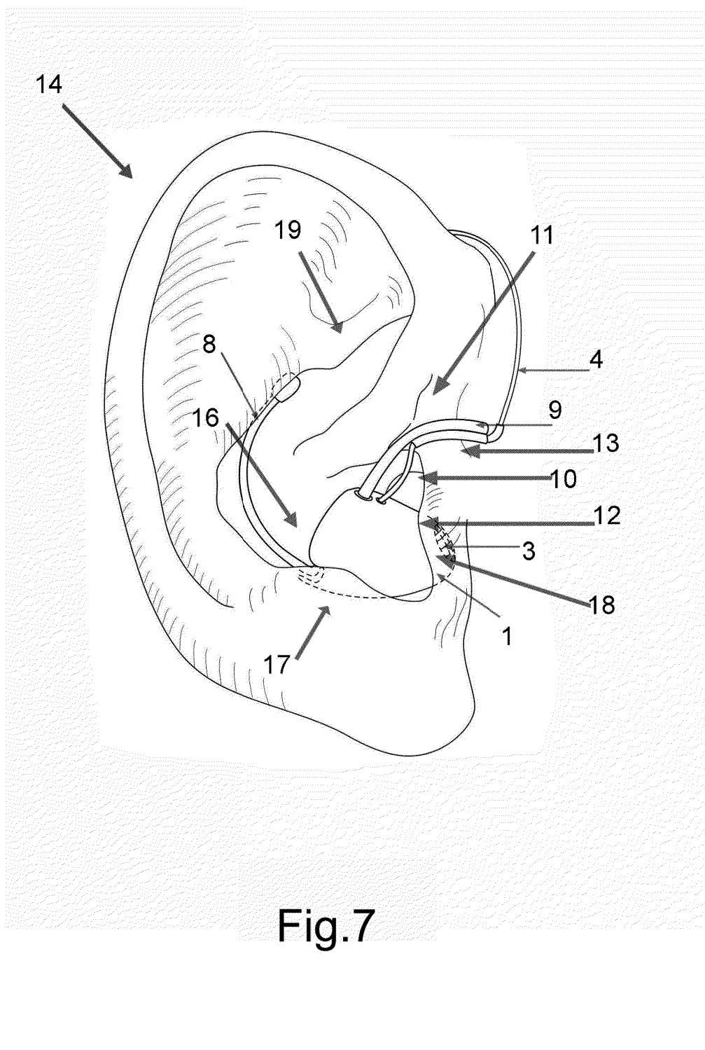

Said guide 9 in the earphone (FIG. 6 and FIG. 7) has a length such that when worn in any of these two positions, said guide is placed at the top of the auricle clipping 10 between leg curl 11 and upper-tragus tubercle 12, and the place of connection of wire 4 and said guide located on the surface of the front ligament of the auricle 13, and the wire goes around the ear 14 from the top, said acoustic part 1 is shaped so that when worn in one of said positions corresponding to the shaft rotation at an angle α 70÷ 90 degrees, said acoustic part at least partially housed within the user's outer auditory canal 15, wherein the sound outlet 3 is recessed into the external auditory canal, a resilient member 8 is located in the cavity of the auricle 16 behind anti-tragus 17 and thus can serve to extract the earphone from the external auditory canal, said acoustic part 1 when wearing the headset by the user in the other above-mentioned position, corresponding to orientation of the guide 9 in the direction of the sound opening 3, located in the cavity of the auricle between the tragus 18 and anti-tragus 17, the sound outlet 3 is located in the vicinity of the entrance of the external auditory canal 15, and a resilient element 8 abuts the lower leg of antihelix 19 and thus serves to keep the earpiece in the auricle.

Thus, the technical objective is solved by creating an earphone the shape of which allows their use in two positions. One of the provisions (FIG. 6), let's call it “quality” corresponds to the position when most of the earphone is placed inside the user's ear canal 15, sound opening 3 is directed toward the eardrum and is located deep inside the ear canal and the earphone housing maximum adjacent to the circumferential walls of the external auditory canal and clogs it. This earphone provision provides better passive noise reduction, reduction of the volume of air rocking by the membrane, resulting in improved sound quality.

The second position (FIG. 7) let's call it “comfort” corresponds to the position earphone in the auricle without penetration of the ear canal, sound opening 3 is located near the entrance to the ear canal, ear canal is free. This provision allows the use of earphones for a long time without overloading the ear canal, without irritating a pressure-sensitive surface of membranous cartilage (front) of the external auditory canal, and also allows the user to hear surrounding sounds.

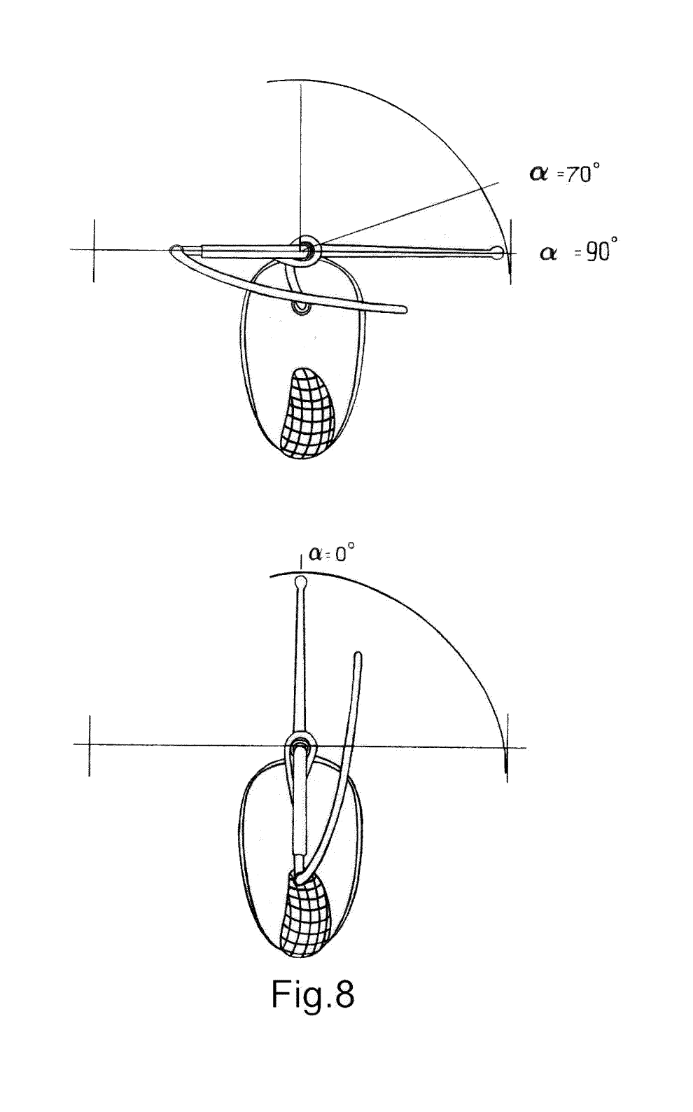

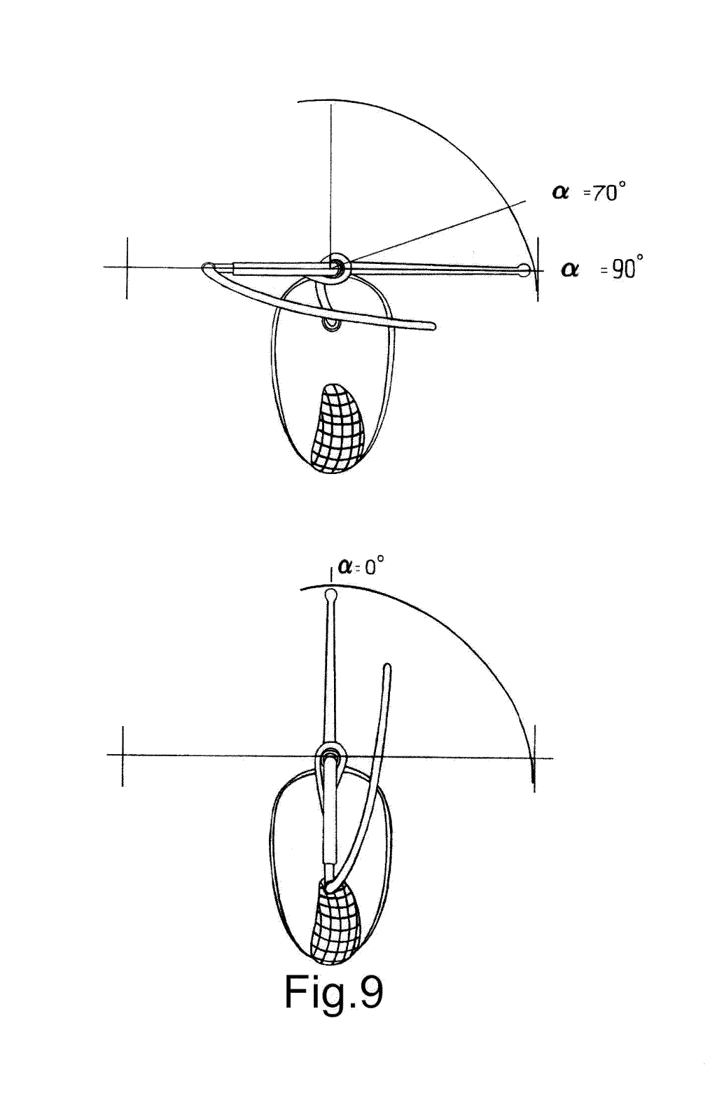

FIG. 8 and FIG. 9 are examples of relative position of the left and right earphone in both positions. FIG. 8 shows top view of the left earphone, where to position the “quality” correspond the angle α in the range of 70 to 90 degrees, when set to “comfort” the angle α is equal to or close to zero. Similarly, the change in positional relationship of parts of right earphone (FIG. 9) when the angle α is changing. The range of the angle α from 70 to 90 degrees in the “quality” position allows taking into account the anatomical structure of the user's ear.

In order to prevent the ejection of the earphone by cartilaginous tissue of the ear in the position “comfort”, a cylindrical hinge may be formed so as to provide sufficient rigidity for shaft rotation, obstructing free rotation of the shaft from that position, wherein the guide wire oriented towards the sound opening.

Given that in the position “comfort” acoustic part of the earphone with the sound opening arranged at its front, can be pressed against the tragus, possible to use several methods of forming the sound opening to prevent it from clogging when wearing the earphone by the user in two positions, namely: to make opening of irregular shape, offset relative to the longitudinal axis of the earphone; increase the diameter of the opening; placing at least two sound openings on different planes; additionally set a convex large-mesh grille. Any combination of these methods is possible.

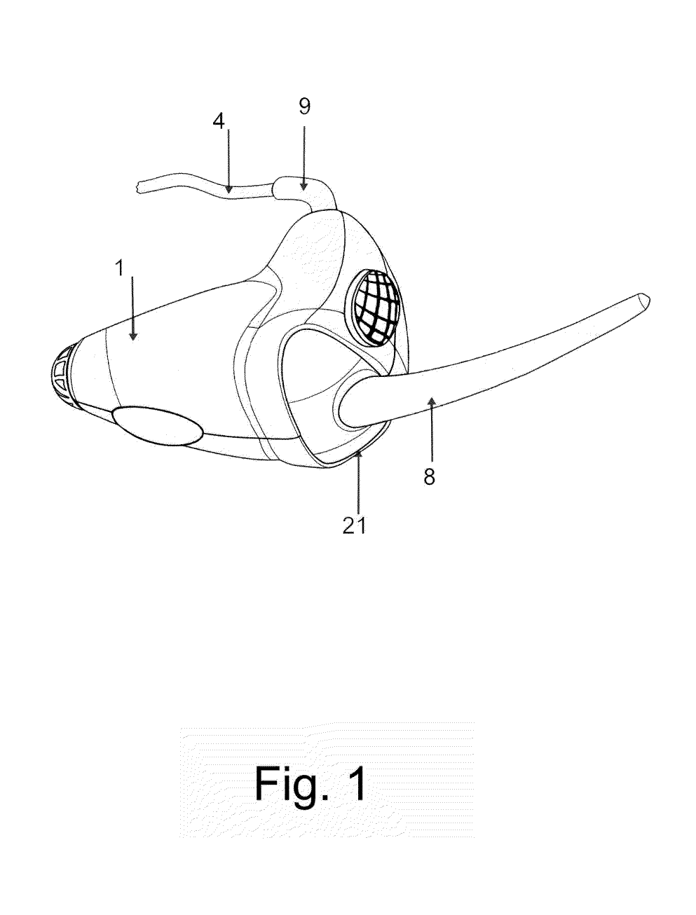

In preferred embodiments, (FIG. 1) the earphone further comprises a protective grille 20, designed for protection from clogging the sound opening.

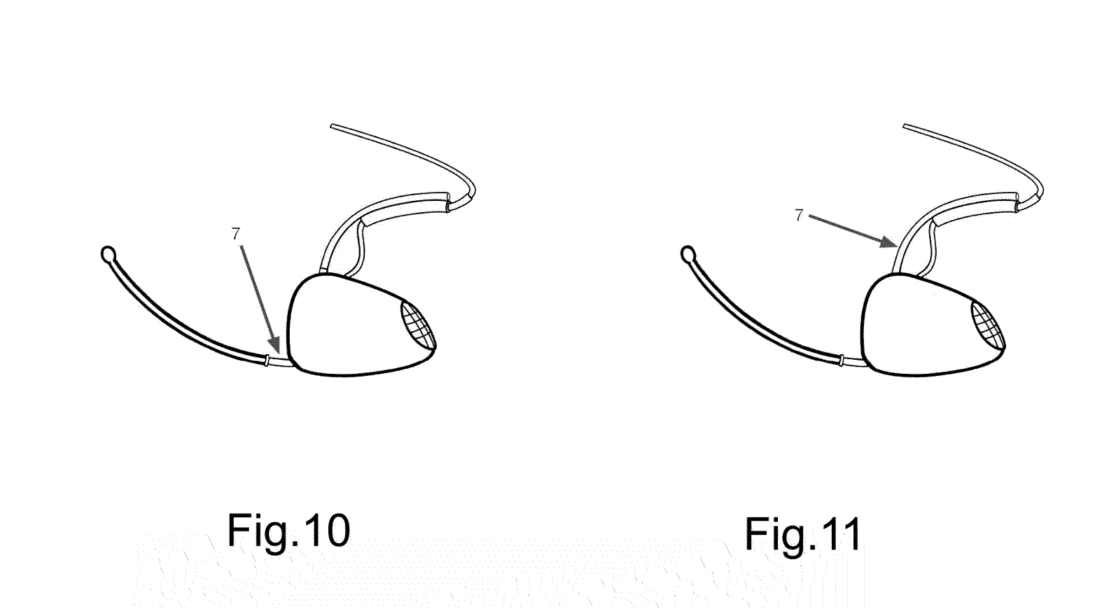

In some embodiments of the earphone (FIG. 10), at least one end of said shaft 7 is curved about the axis of rotation.

In many embodiments of the earphone (FIG. 11), both ends of the shaft 7 are bent in opposite directions from the axis of rotation.

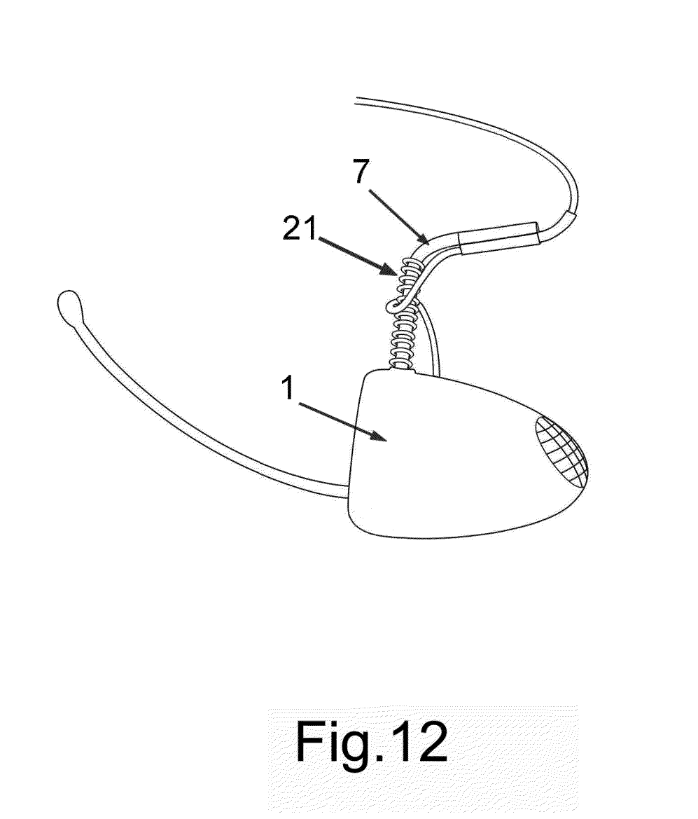

In various embodiments, the earphone further comprises a return mechanism, which returning shaft to a position wherein the guide is oriented towards the sound opening, and the angle alpha is close to or equal to 0. The return mechanism 21 (FIG. 12) may be designed as a cylindrical helical spring loosely wound around the shaft 7, wherein one end of the spring is attached to the acoustic portion 1 and the other end of the spring is attached to one end of said shaft. FIG. 8 shows the right earphone in the “comfort” position. In some embodiments, the return mechanism can be configured as a bending spring, one end of which is attached to one end of the shaft and the other end is attached to the acoustic part of the earphone.

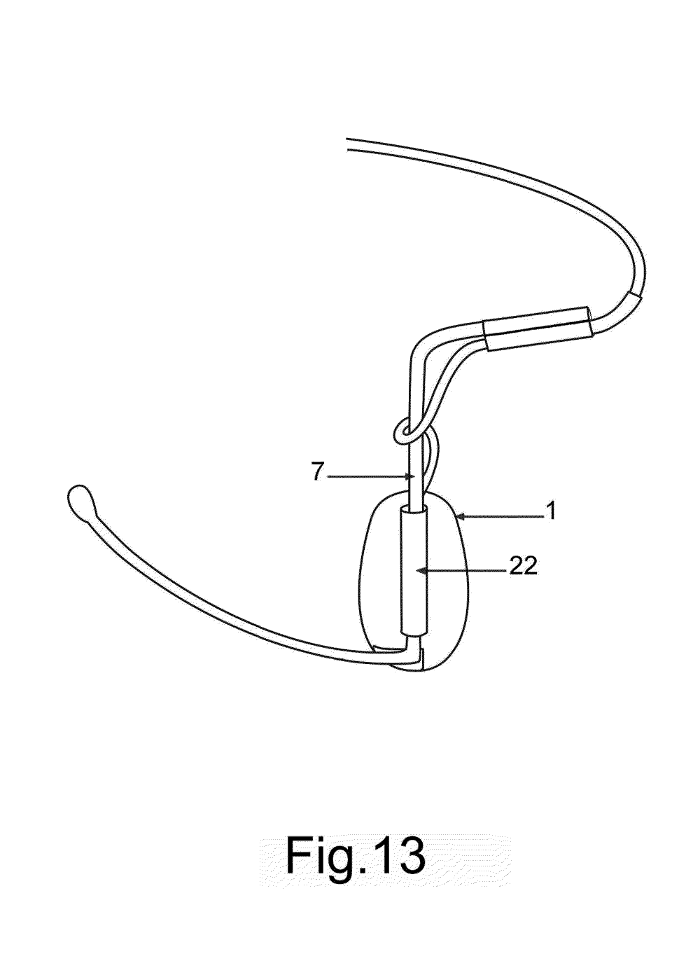

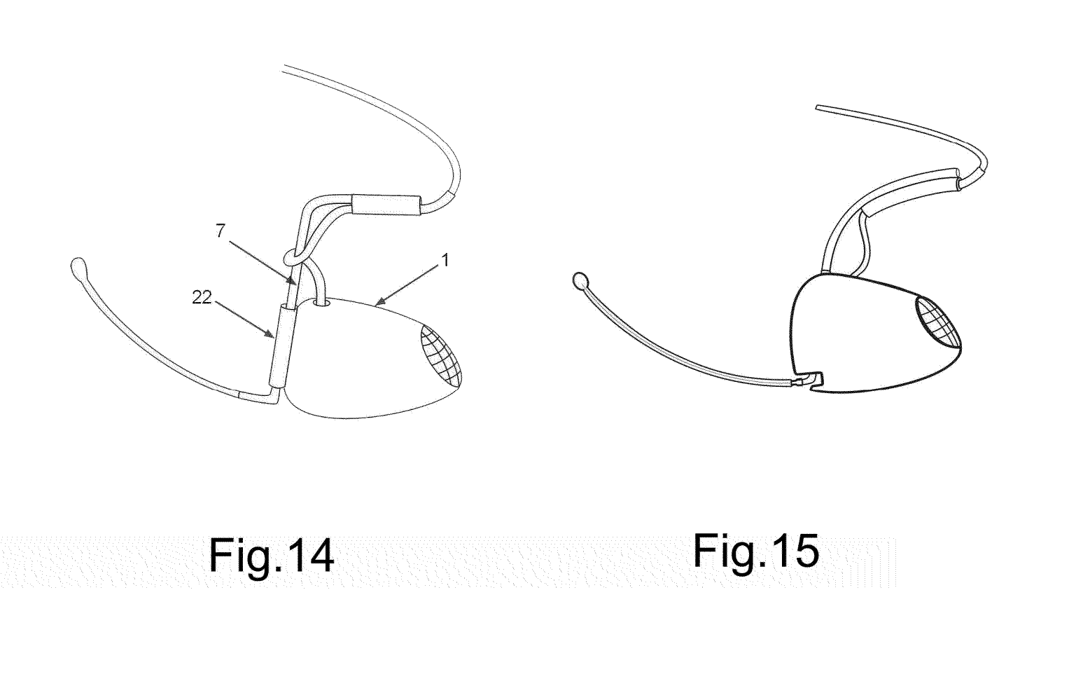

In many embodiments of the earphone (FIG. 13 and FIG. 14), a cylindrical hinge further comprises at least one sleeve 22 in which is located said shaft 7.

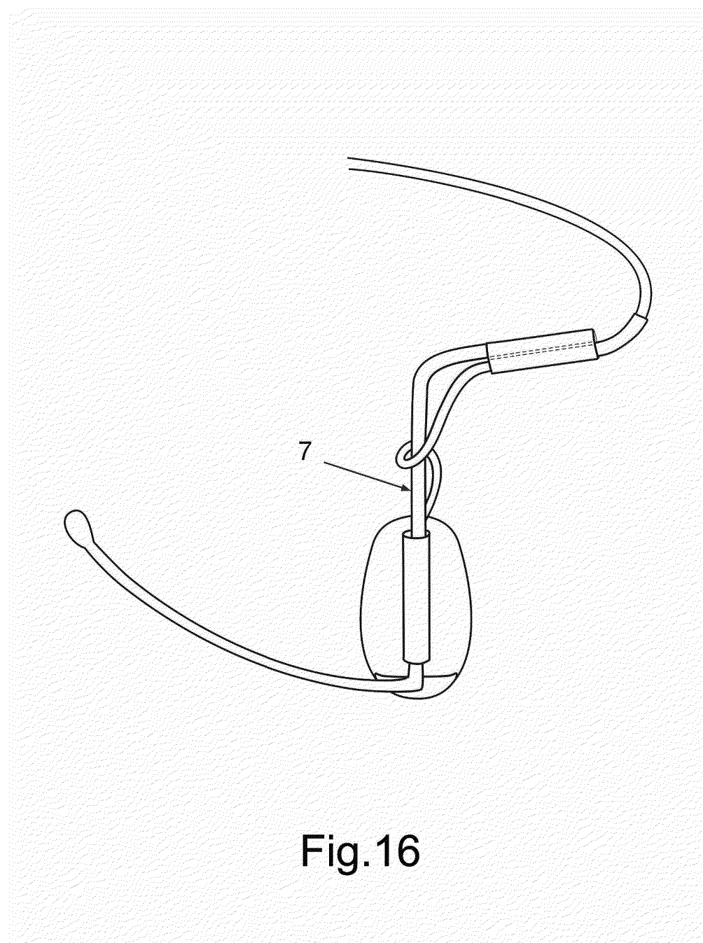

In preferred embodiments of the earphone (FIG. 15 and FIG. 16) the mechanical part may be arranged to rotate the shaft 7 at an angle α in the range of 70 to 90 degrees in either direction from a position wherein said guide is oriented in the direction toward said sound opening.

FIG. 15 and FIG. 16 shows an embodiment of the earphone implemented to be worn in the either user's ear.

In the embodiments in which the rotation of the shaft is provided in any direction and use of the earphone is available in the user's either ear, exact location of the earphone is carried out by hardware methods, e.g., using a microphone and (or) accelerometers placed in the earphones.

In various embodiments (FIG. 2) at the section between places of fastening of the wire 4 to the guide 9 and to the acoustic transducer 2, wire 4 may have additional slack to allow rotation of the shaft 7.

In some cases, this portion of wire has several loose rounds (FIG. 14 and FIG. 16), entwined around the upper portion of the shaft, the wire may be formed into a loose, slack cylindrical spring entwined in a similar manner.

In some cases, this portion of wire having slack to ensure the necessary rotation of the shaft, located inside the protective shell of the earphone.

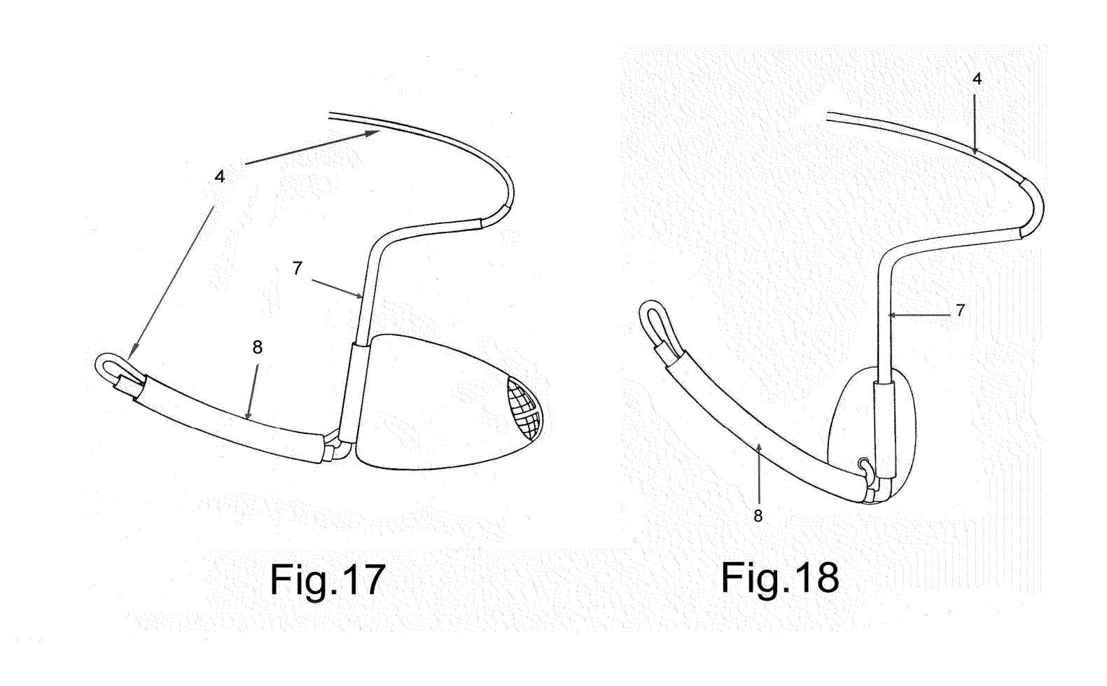

In some embodiments of the earphone (FIG. 17 and FIG. 18) the shaft 7 and a resilient member 8 may be made hollow, wire 4 is placed inside the shaft and the resilient member and further mechanically fastened to the lower end of the shaft, forming a loop, and the portion of wire between places of additional fastening of wire to the lower end of the shaft and to the electroacoustic transducer has an extra slack.

Where possible the partial pull of the wires inside the shaft, the user can adjust the length of the wire loop that serves to hold the earphone in the auricle.

In some embodiments, said wire may further comprise an electric socket on the section between the places of fastening to the upper part of the shaft and to the acoustic transducer.

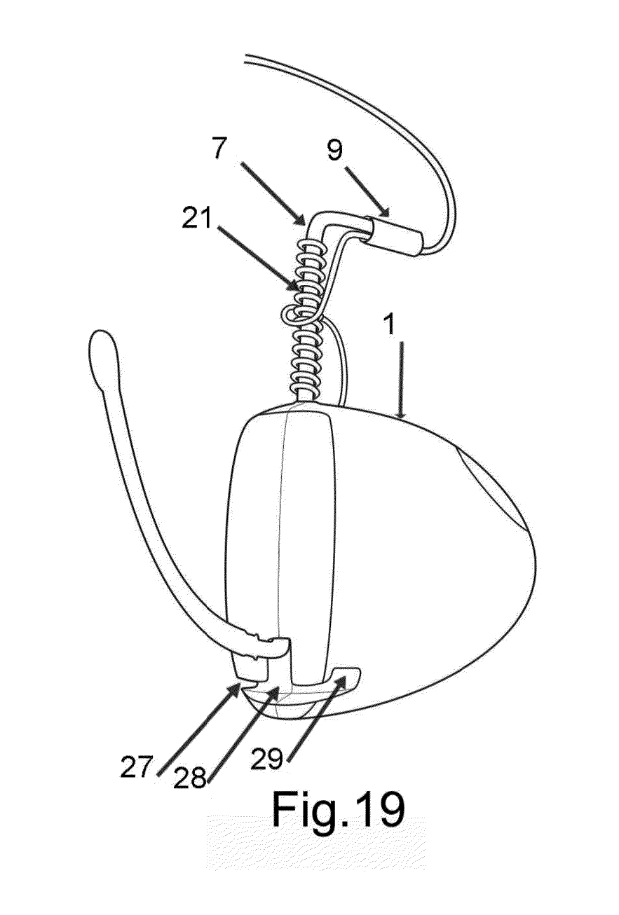

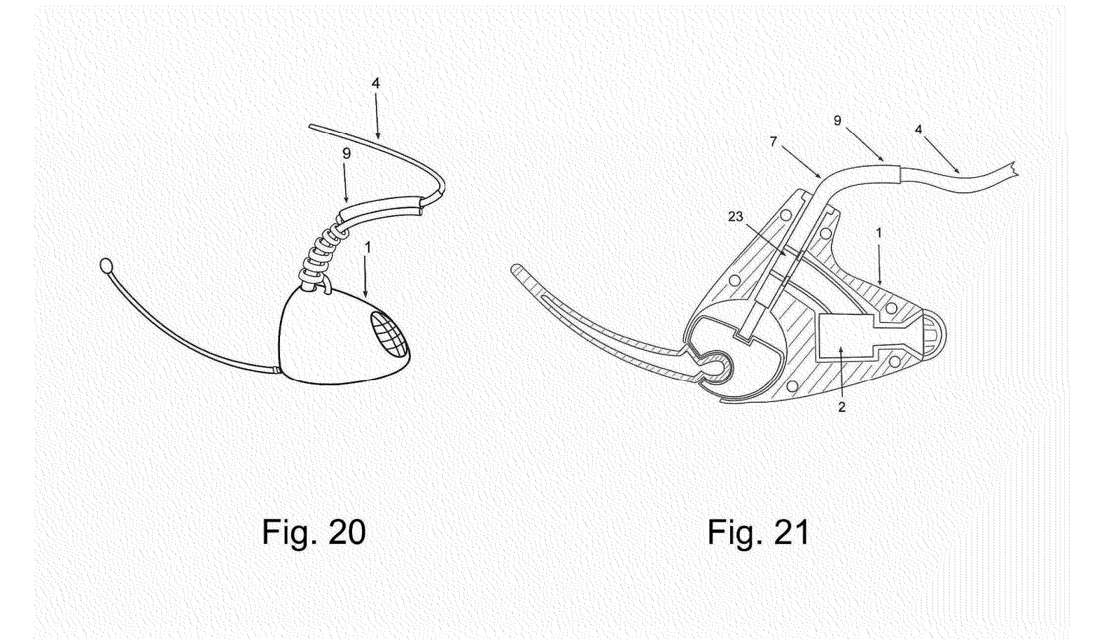

In many embodiments of the earphone (FIG. 19) said shaft 7 is arranged for longitudinal movement in said cylindrical hinge. Also, the earphone may further comprise a twisted cylindrical compression spring 21, wound around the shaft between the guide 9 and acoustics part 1 or (FIG. 20) part of said wire 4 located between guide 9 and acoustic part 1 may be implemented as a twisted cylindrical compression spring wound around the shaft.

In various embodiments of the earphone (FIG. 21) guide 9 and said shaft 7 can be made hollow, wire 4 positioned within said cavities, and a cylindrical hinge may further comprise brush-commutator assembly 23, adapted to be able electrically connecting said wire with the electroacoustic transducer 2.

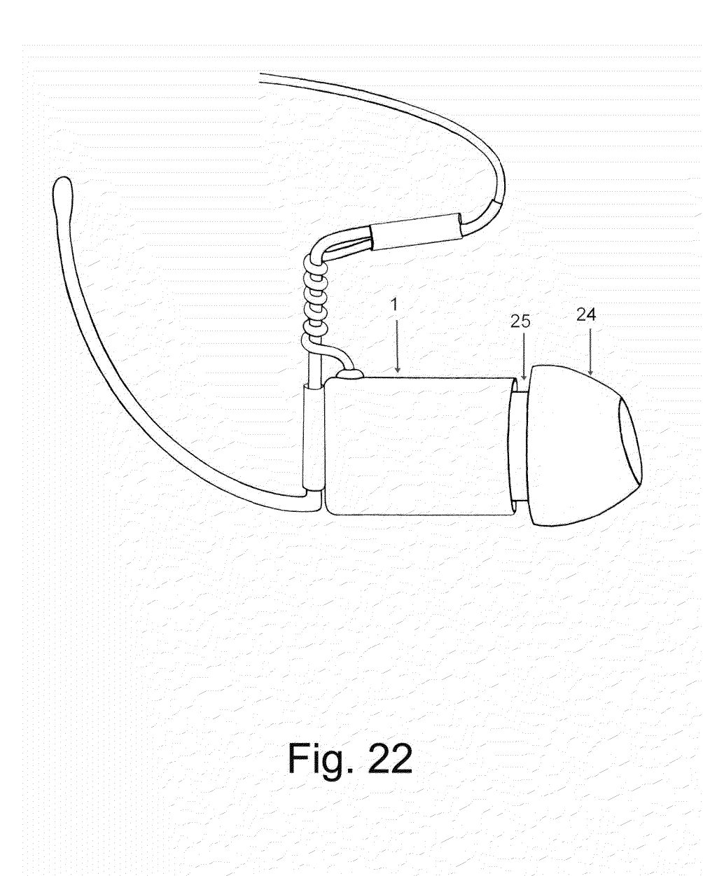

In some embodiments (FIG. 22) the earphone further comprises an embouchure 24, and said acoustic part 1 is further provided with fasteners 25 for it.

In some embodiments, the earphone may further comprise a soft cover designed to fit over the acoustics portion of the earphone, and in some embodiments, at least partially, on the resilient element.

Wherein said cover has at least one opening serving for the sound output and located opposite said sound opening when wearing the cover. The earphone may be provided with a set of covers of different sizes, textures and colors, using which the user adjusts the size, shape and color of the earphone. When using a microphone, additionally placed on the earphone, said soft cover can serve as an additional windscreen to said microphone, wherein said cover may at least partially serve as a resilient element of the earphone.

In advantageous embodiments, the (FIG. 10) resilient element may be made detachable. This allows make a set of replaceable resilient elements of different lengths and rigidity to meet the user's requirements for comfort wearing and fixing of the earphone. The resilient member may be made of rubber, a spiral spring, a combination of these materials, or be an integral part of the cover.

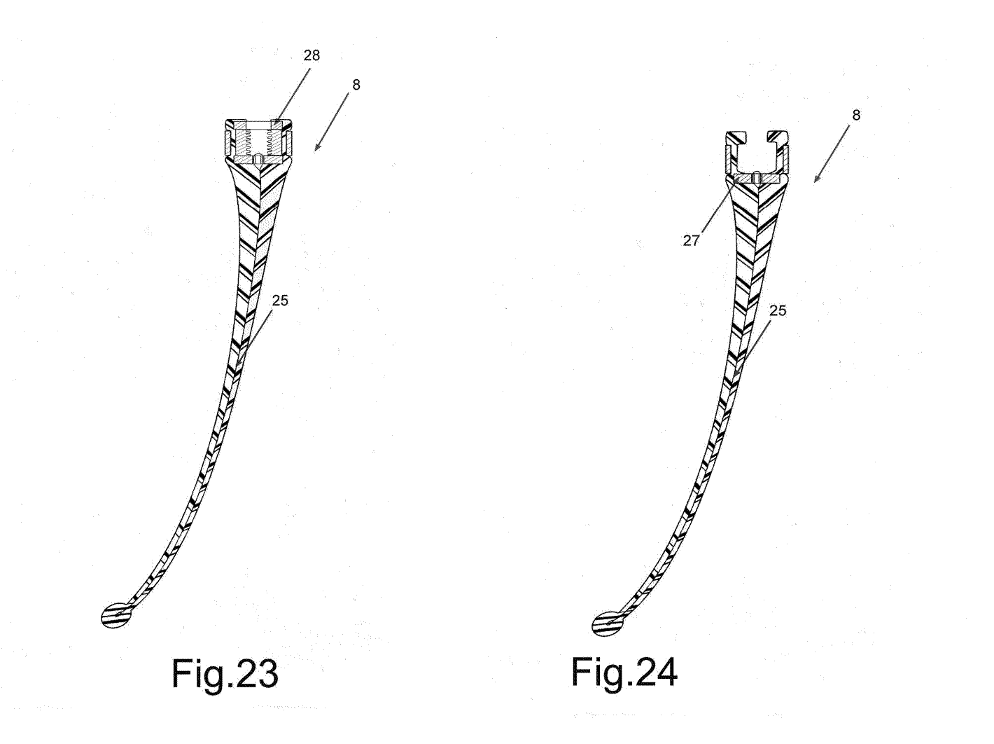

In various embodiments (FIG. 23 and FIG. 24), the resilient element 8 further comprising a longitudinal rigid thread 26, secured within the resilient member 8, and the resilient member may be arranged to adjust the length. It is advisable to insert a sturdy thread 26 longitudinally inside the elastic member 8, wherein tread 26 will prevent breakage of the resilient element in the case of stretching the resilient element of earphone from deep intra-canal position. Thread 26 is fixed in the resilient element by a washer 27 or secured to the threaded sleeve 28.

In some embodiments of the earphone the resilient element is formed as a loop.

Headset, in the embodiment illustrated in FIG. 19 further comprises at least one latch, adapted to hold the shaft, at least in one of said positions. Earphone shown in FIG. 19 intended to be worn in the either ear of the user and comprises latches 29, 30 and 31, where the latch 31 is designed to hold the shaft 7 when wearing earphone in either user's ear in the “comfort” position, latch 29 is engaged in the “quality” position when using earphone as a right, latch 30—using earphone as left, respectively.

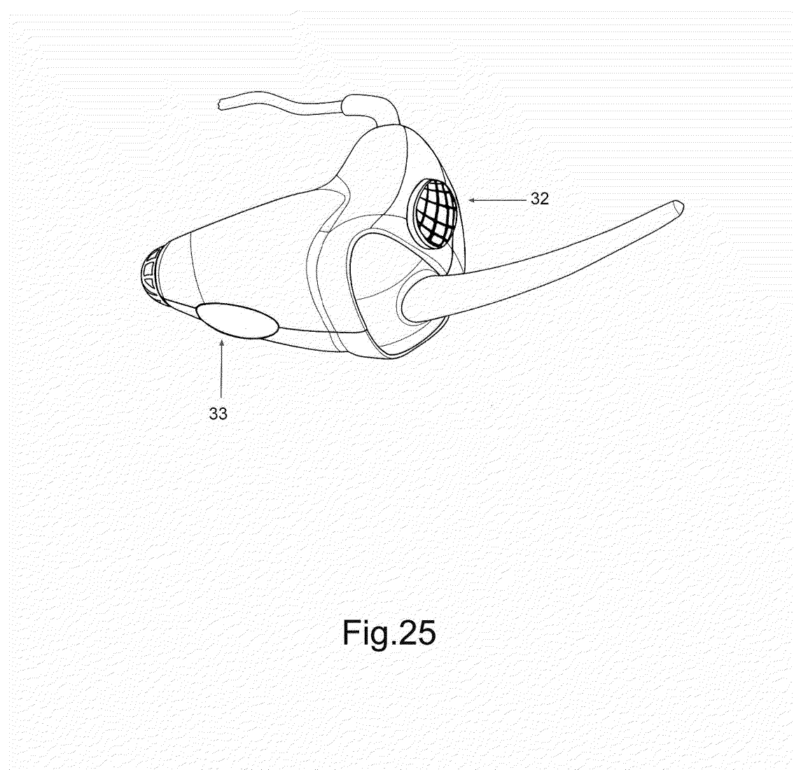

In some embodiments (FIG. 25) earphone may further comprise at least one microphone 32, and may further comprise a bone conduction microphone 33. Earphone may further comprise an air conduction microphone to form a microphone array in wearable headset or to provide an active noise-suppression when listening to music; a bone conduction microphone is designed to remove the voice carrier with minimal noise.

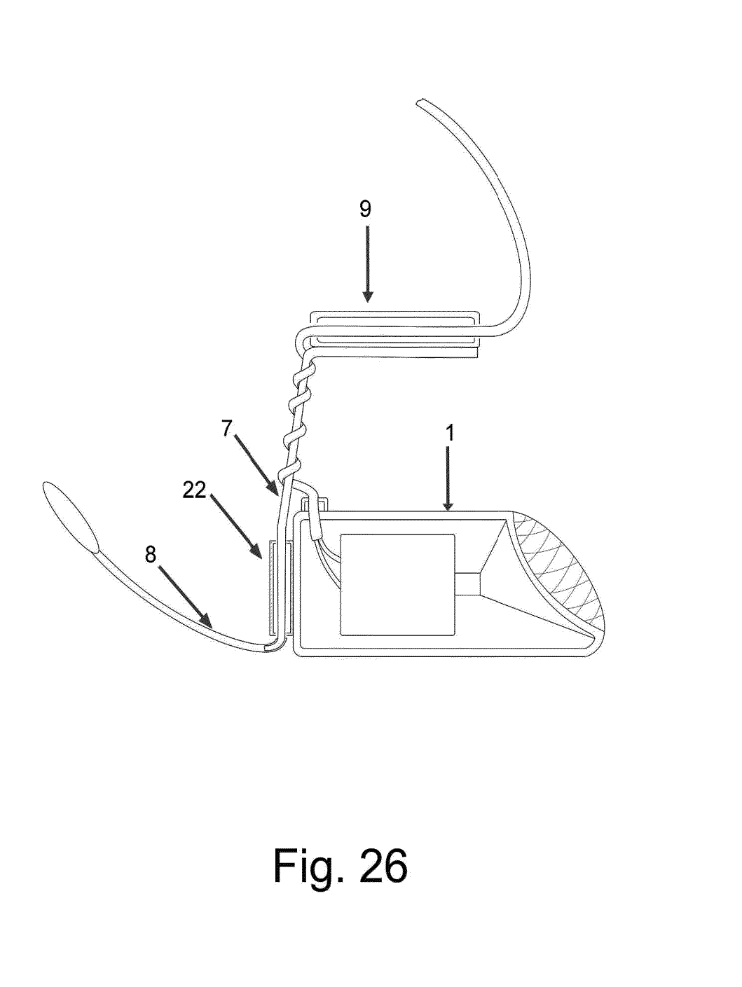

A simple embodiment of the earphone is shown in FIG. 26. Acoustic part 1 can have a simple cylinder shape, to which through the sleeve 22 attached shaft 7 and a resilient member 8 and the guide 9. Earphone shape close to a cylindrical or has the shape of a cylinder flattened on both sides and elongated in the longitudinal direction. The length of a fixed rotating shaft portion may be from 5 mm to 15 mm, length of the resilient member formed in such a way that it may be a continuation of the curved bottom of the shaft, equal to, depending on the Entre-metric data user, from 15 to 30 mm. The size and shape of the upper part of the shaft, together with the guide attached to the shaft, are equal to 15-25 mm, which allows the use of this part of earphone as a abutting into front ligament of the auricle, which prevents loss of earphone when wearing in either of two positions.

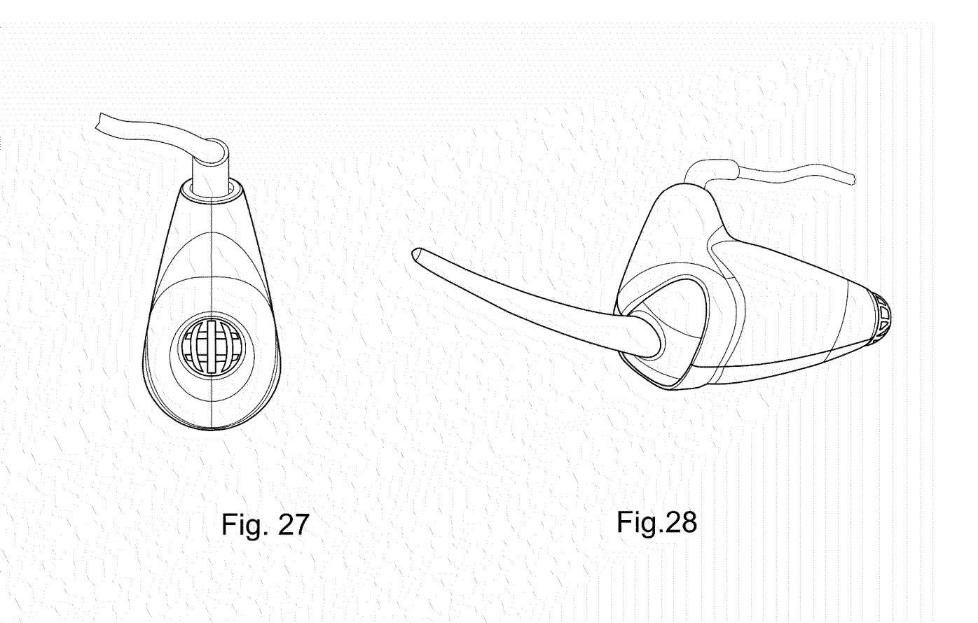

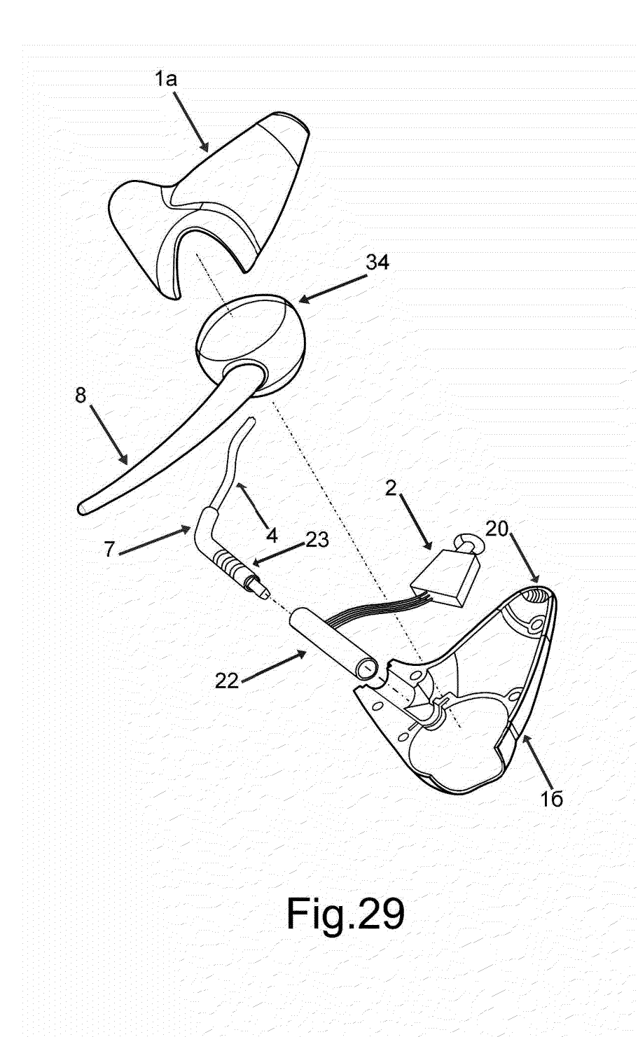

In one embodiment of the earphone (FIGS. 27, 28, and 29) connection of the shaft with the resilient element is made in the form of a ball, rotating in cavity of the spherical hinge. The design features of the earphone are presented in FIG. 25. Earphone acoustic portion 1 is made of two parts 1a and 1b. Shaft 7 is curved at one end and is attached to the acoustic part by means of a sleeve 22. On the sleeve and the shaft is placed brush-collector mechanism connecting the wire 4 with electro-acoustic transducer. In this embodiment, the use of electro-acoustic transducer is provided with a balanced armature, allowing reduces the overall size and leaves room for placement of microphones in the acoustic part of the earphone or the cavity of said rotating sphere. Flexible element 8 comprises a spherical socket 24, firmly placed in the respective cavity of the acoustic parts 1 and latching in it by the shaft 7.

When creating earphones favored the design solutions, that make the earphones maximally flat and the least hook-shaped, since when using earphones in the device ever worn on the body, being removed from the ear, earphones positioned on the body under the clothing. Furthermore, in some wearable devices provides for the winding of wire of the earphones followed by placing earphones in a special cavity or pocket of the worn device. The more flat earphones are the more comfortable will be wearing them on the body in a variety of devices of wearable electronics.

An in-the-ear earphone (FIG. 2) to be worn in two positions comprises acoustic part 1, comprising at least one electroacoustic transducer 2, and at least one sound opening 3, intended for an acoustic output signal, generated by electro-acoustic transducer, further, an in-the-ear earphone comprises wire 4, electrically connected to said electroacoustic transducer 2, mechanical part 5 coupled to said acoustic part 1 by means of a cylindrical hinge 6, and comprising rotatable shaft 7, the resilient member 8 connected to one end of said shaft, guide wires 9 connected to the opposite end of said shaft, wherein, said resilient member 8 and the guide 9 having its large part in one plane with the axis of shaft rotation, and are oriented essentially in opposite directions from the axis of shaft rotation, wherein said sound opening 3 is located at the end of acoustic part, opposing cylindrical hinge 6, said end of acoustic part configured so as to prevent clogging of the sound opening during wearing in any of said positions, said cylindrical hinge 6 is formed so as to allow rotation of said shaft 7 by an angle α, which is at least 70 degrees from a position wherein said guide 9 is oriented towards the sound opening 3, said wire 4 is mechanically connected to said guide 9, wherein said guide 9 in the earphone (FIG. 6 and FIG. 7) has a length such that when worn in any of these two positions, said guide is placed at the top of the auricle clipping 10 between leg curl 11 and upper-tragus tubercle 12, and the place of connection of wire 4 and said guide located on the surface of the front ligament of the auricle 13, and the wire goes around the ear 14 from the top, said acoustic part 1 is shaped so that when worn in one of said positions corresponding to the shaft rotation at an angle α 70÷90 degrees, said acoustic part at least partially housed within the user's outer auditory canal 15, wherein the sound outlet 3 is recessed into the external auditory canal, a resilient member 8 is located in the cavity of the auricle 16 behind anti-tragus 17 and thus can serve to extract the earphone from the external auditory canal, said acoustic part 1 when wearing the headset by the user in the other above-mentioned position, corresponding to orientation of the guide 9 in the direction of the sound opening 3, located in the cavity of the auricle between the tragus 18 and anti-tragus 17, the sound outlet 3 is located in the vicinity of the entrance of the external auditory canal 15, and a resilient element 8 abuts the lower leg of antihelix 19 and thus serves to keep the earpiece in the auricle.

Thus, the technical objective is solved by creating an earphone the shape of which allows their use in two positions. One of the provisions (FIG. 6), let's call it “quality” corresponds to the position when most of the earphone is placed inside the user's ear canal 15, sound opening 3 is directed toward the eardrum and is located deep inside the ear canal and the earphone housing maximum adjacent to the circumferential walls of the external auditory canal and clogs it. This earphone provision provides better passive noise reduction, reduction of the volume of air rocking by the membrane, resulting in improved sound quality.

The second position (FIG. 7) let's call it “comfort” corresponds to the position earphone in the auricle without penetration of the ear canal, sound opening 3 is located near the entrance to the ear canal, ear canal is free. This provision allows the use of earphones for a long time without overloading the ear canal, without irritating a pressure-sensitive surface of membranous cartilage (front) of the external auditory canal, and also allows the user to hear surrounding sounds.

FIG. 8 and FIG. 9 are examples of relative position of the left and right earphone in both positions. FIG. 8 shows top view of the left earphone, where to position the “quality” correspond the angle α in the range of 70 to 90 degrees, when set to “comfort” the angle α is equal to or close to zero. Similarly, the change in positional relationship of parts of right earphone (FIG. 9) when the angle α is changing. The range of the angle α from 70 to 90 degrees in the “quality” position allows taking into account the anatomical structure of the user's ear.

In order to prevent the ejection of the earphone by cartilaginous tissue of the ear in the position “comfort”, a cylindrical hinge may be formed so as to provide sufficient rigidity for shaft rotation, obstructing free rotation of the shaft from that position, wherein the guide wire oriented towards the sound opening.

Given that in the position “comfort” acoustic part of the earphone with the sound opening arranged at its front, can be pressed against the tragus, possible to use several methods of forming the sound opening to prevent it from clogging when wearing the earphone by the user in two positions, namely: to make opening of irregular shape, offset relative to the longitudinal axis of the earphone; increase the diameter of the opening; placing at least two sound openings on different planes; additionally set a convex large-mesh grille. Any combination of these methods is possible.

In preferred embodiments, (FIG. 2) the earphone further comprises a protective grille 20, designed for protection from clogging the sound opening.

In some embodiments of the earphone (FIG. 10), at least one end of said shaft 7 is curved about the axis of rotation.

In many embodiments of the earphone (FIG. 11), both ends of the shaft 7 are bent in opposite directions from the axis of rotation.

In various embodiments, the earphone further comprises a return mechanism, returning shaft to a position wherein the guide is oriented towards the sound opening, and the angle alpha is close to or equal to 0. The return mechanism 21 (FIG. 12) may be formed as a cylindrical helical spring loosely wound around the shaft 7, wherein one end of the spring is attached to the acoustic portion 1 and the other end of the spring is attached to one end of said shaft. FIG. 8 shows the right earphone in the “comfort” position.

In some embodiments, the return mechanism can be configured as a bending spring, one end of which is attached to one end of the shaft and the other end is attached to the acoustic part of the earphone.

Headset, in the embodiment illustrated in FIG. 19 further comprises at least one latch, adapted to hold the shaft, at least in one of said positions. Earphone shown in FIG. 19 intended to be worn in the either ear of the user and comprises latches 29, 30 and 31, where the latch 31 is designed to hold the shaft 7 when wearing earphone in either user's ear in the “comfort” position, latch 29 is engaged in the “quality” position when using earphone as a right, latch 30—using earphone as left, respectively.

In preferred embodiments of the earphone (FIG. 15 and FIG. 16) the mechanical part may be arranged to rotate the shaft 7 at an angle α in the range of 70 to 90 degrees in either direction from a position wherein said guide is oriented in the direction toward said sound opening. FIG. 15 and FIG. 16 shows an embodiment of the earphone implemented to be worn in the user's either ear.

In the embodiments in which the rotation of the shaft is provided in any direction and use of the earphone is available in the user's either ear, exact location of the earphone is carried out by hardware methods, e.g., using a microphone and (or) accelerometers placed in the earphones.

In various embodiments (FIG. 2) in the area between places of fastening of the wire 4 to the guide 9 and to the acoustic transducer 2, wire 4 may have additional slack to allow rotation of the shaft 7.

In some cases, this portion of wire has several loose rounds (FIG. 14 and FIG. 16), entwined around the upper portion of the shaft, the wire may be formed into a loose, slack cylindrical spring entwined in a similar manner.

In some cases, this portion of wire having slack to ensure the necessary rotation of the shaft, located inside the protective shell of the earphone.

In some embodiments of the earphone (FIG. 17 and FIG. 18) the shaft 7 and a resilient member 8 may be made hollow, wire 4 is placed inside the shaft and the resilient member and further mechanically fastened to the lower end of the shaft, forming a loop, and the portion of wire between places of additional fastening of wires to the lower end of the shaft and to the electroacoustic transducer has an extra slack.

Where possible the partial pull of the wires inside the shaft, the user can adjust the length of the wire loop that serves to hold the earphone in the auricle.

In some embodiments, said wire may further comprise an electric socket on the section between the places of fastening to the upper part of the shaft and to the acoustic transducer.

In many embodiments of the earphone (FIG. 19) said shaft 7 is arranged for longitudinal movement in said cylindrical hinge. Also, the earphone may further comprise a twisted cylindrical compression spring 21, wound around the shaft between the guide 9 and acoustics part 1 or (FIG. 20) part of said wire 4 located between guide 9 and acoustic part 1 may be implemented as a twisted cylindrical compression spring wound around the shaft.

In various embodiments of the earphone (FIG. 21) guide 9 and said shaft 7 can be made hollow, wire 4 positioned within said cavities, and a cylindrical hinge may further comprise brush-commutator assembly 23, adapted to be electrically connected of said wire with the electroacoustic transducer 2.

In some embodiments (FIG. 22) the earphone further comprises an embouchure 24, and said acoustic part 1 is further provided with fasteners 25 for it.

In some embodiments, the earphone may further comprise a soft cover designed to fit over the acoustics portion of the earphone, and in some embodiments, at least partially, on the resilient element. Wherein said cover has at least one opening serving for the sound output and located opposite said sound opening when wearing the cover. The earphone may be provided with a set of covers of different sizes, textures and colors, using which the user adjusts the size, shape and color of the earphone. When using a microphone, additionally placed on the earphone, said soft cover can serve as an additional windscreen to said microphone, wherein said cover may at least partially serve as a resilient element of the earphone.

In advantageous embodiments, the (FIG. 10) resilient element may be made detachable. This allows make a set of replaceable resilient elements of different lengths and rigidity to meet the user's requirements for comfort wearing and fixing of the earphone. The resilient member may be made of rubber, a spiral spring, a combination of these materials, or be an integral part of the cover.

In various embodiments (FIG. 23 and FIG. 24), the resilient element 8 further comprising a longitudinal rigid thread 26, secured within the resilient member 8, and the resilient member may be arranged to adjust the length. It is advisable to insert a sturdy thread 26 longitudinally inside the elastic member 8, wherein tread 26 will prevent breakage of the resilient element in the case of stretching the resilient element of earphone from deep intra-canal position. Thread 26 is fixed in the resilient element by a washer 27 or secured to the threaded sleeve 28. In various embodiments, the resilient element may have an adjustable length.

In some embodiments of the earphone the resilient element is formed as a loop.

In many embodiments of the earphone (FIG. 13 and FIG. 14), a cylindrical hinge further comprises at least one sleeve 22 in which is located said shaft 7.

In some embodiments (FIG. 25) earphone may further comprise at least one microphone 32, and may further comprise a bone conduction microphone 33. Earphone may further comprise an air conduction microphone to form a microphone array in wearable headset or to provide an active noise-suppression when listening to music; a bone conduction microphone is designed to remove the voice carrier with minimal noise.

A simple embodiment of the earphone is shown in FIG. 26. Acoustic part 1 can have a simple cylinder shape, to which through the sleeve 22 attached shaft 7 and a resilient member 8 and the guide 9. Earphone shape close to a cylindrical or has the shape of a cylinder flattened on both sides and elongated in the longitudinal direction. The length of a fixed rotating shaft portion may be from 5 mm to 15 mm, length of the resilient member formed in such a way that it may be a continuation of the curved bottom of the shaft, equal to, depending on the Entre-metric data user, from 15 to 30 mm. The size and shape of the upper part of the shaft, together with the guide attached to the shaft, are equal to 15-25 mm, which allows the use of this part of earphone as a abutting into front ligament of the auricle, which prevents loss of earphone when wearing in either of two positions.

In one embodiment of the earphone (FIGS. 27, 28, and 29) connection of the shaft with the resilient element is made in the form of a ball, rotating in cavity of the spherical hinge. The design features of the earphone are presented in FIG. 25. Earphone's acoustic portion 1 is made of two parts 1a and 1b. Shaft 7 is curved at one end and is attached to the acoustic part by means of a sleeve 22. On the sleeve and the shaft is placed brush-collector mechanism connecting the wire 4 with electro-acoustic transducer. In this embodiment, the use of electro-acoustic transducer is provided with a balanced armature, allowing reduces the overall size and leaves room for placement of microphones in the acoustic part of the earphone or the cavity of said rotating sphere. Flexible element 8 comprises a spherical socket 24, firmly placed in the respective cavity of the acoustic parts 1 and latching in it by the shaft 7.

When creating earphones favored the design solutions, that make the earphones maximally flat and the least hook-shaped, since when using earphones in the device ever worn on the body, being removed from the ear, earphones positioned on the body under the clothing. Furthermore, in some wearable devices provides for the winding of wire of the earphones followed by placing earphones in a special cavity or pocket of the worn device. The more flat earphones are the more comfortable will be wearing them on the body in a variety of devices of wearable electronics.

FIG. 6 and FIG. 7 shows a way of wearing in-the-ear earphone in two positions where the earphone (FIG. 2) comprising an acoustic part 1 comprising at least one electroacoustic transducer 2 and at least one sound opening 3 designed to output an acoustic signal generated by the electroacoustic transducer; earphone also comprising a wire 4, electrically connected with said electroacoustic transducer 2, the mechanical part 5, connected with said acoustic part 1 through a cylindrical hinge 6 and having a shaft 7, rotatable, the resilient element 8, connected to one end of said shaft, a guide wire 9 connected to the opposite end of said shaft, wherein, said resilient member 8 and the guide 9 are located at its greater part in the same plane with the axis of the rotation of the shaft and oriented substantially in opposite directions from the axis of rotation of the shaft, wherein said sound opening 3 is located at the end of the acoustic part, opposing cylindrical hinge 6, said end portion of acoustic part is designed in such a way to exclude the possibility of clogging the sound opening when wearing in any of said positions, said cylindrical hinge 6 is designed in such a way to permit rotation of said shaft 7 by an angle α, which is at least 70 degrees from the position wherein said guide 9 is oriented towards the sound opening 3, said wire 4 is mechanically connected with said guide 9, a method wherein, for arranging the sound opening 3 in the external auditory canal 15 (FIG. 6), the user turns the shaft 7 at an angle α, which is at least 70 degrees from a position wherein said guide 9 is oriented towards the sound opening 3, arranges acoustic part 1 within the external auditory openings, wherein a user places the resilient member 8 in the cavity of the auricle behind anti-tragus 17, as for arranging the sound opening 3 on the outside from the entrance of the external auditory canal 15 (FIG. 7), a user rotates the shaft 7 to a position where the upper part of the shaft directed towards the acoustical opening 3, arranges acoustic part 1 in the cavity of the auricle between the tragus 18 and anti-tragus 17, a resilient member 8 in the in the cavity of the auricle behind the anti-tragus 17, wherein, when worn in any of said two positions, the user places said guide wire 9 at the top clipping of the ear auricle 10 between the leg curl 11 and upper-tragus tubercle 12, place of connection of wire 4 and said guide on the surface of the front ligament of the auricle 13, and wire from the top of the auricle 14.

1. In-the-ear earphone to be worn in two positions, comprising:
an acoustic part comprising at least one electroacoustic transducer and at least one sound opening designed to output an acoustic signal generated by the electroacoustic transducer,
a wire, electrically connected with said electroacoustic transducer,
the mechanical part, connected with said acoustic part through a cylindrical hinge and having
a shaft designed to be rotatable,
the resilient element, connected to one end of said shaft,
a guide wire connected to the opposite end of said shaft, wherein, said resilient member and the guide are located at its greater part in the same plane with the axis of rotation of the shaft and oriented substantially in opposite directions from the axis of rotation of the shaft;
wherein said sound opening is located at the end of the acoustic part, opposing cylindrical hinge;
said end portion of acoustic part is designed in such a way as to exclude the possibility of clogging the sound opening when wearing in any of said positions;
said cylindrical hinge is designed in such a way to permit rotation of said shaft by an angle α, which is at least 70 degrees from the position wherein said guide is oriented towards the sound opening;
said wire is mechanically connected with said guide.

2. Earphone according to the claim 1, wherein, said guide has such a length that when worn in any of said two positions, said guide is placed at the top clipping of the auricle between leg curl and upper-tragus tubercle, wherein, the place of connection of the wire and said guide is located on the surface of the front ligament of the auricle, wherein the wire goes around the ear from the top,
said acoustic part is shaped so that when worn in one of said positions corresponding to the shaft rotation at an angle α 70÷90 degrees, said acoustic part at least partially housed within the user's outer auditory canal, wherein the sound outlet is recessed into the external auditory canal, a resilient member is located in the cavity of the auricle behind anti-tragus and thus can serve to extract the earphone from the external auditory canal;
said acoustic part when wearing in other said position, corresponding to the orientation of the guide in the direction of the sound opening, located in the cavity of the auricle between the tragus and anti-tragus, the sound outlet is located in the vicinity of the entrance of the external auditory canal, and a resilient element abuts the lower leg of antihelix and thus serves to keep the earpiece in ear.

3. Earphone according to the claim 1, wherein the earphone further comprises a protective grille designed for protection from clogging the sound opening.

4. Earphone according to the claim 1, wherein at least the one end of the shaft is curved about the axis of rotation.

5. Earphone according to the claim 4, wherein both ends of the shaft are bent in opposite directions from the axis of rotation.

6. Earphone according to the claim 1, wherein the earphone further comprises a return mechanism, which returning shaft to a position wherein the guide is oriented towards the sound opening and the angle alpha is close to or equal to 0.

7. Earphone according to the claim 6, wherein the return mechanism is designed as a cylindrical helical spring loosely wound around the shaft, wherein one end of the spring is attached to the acoustic portion and the other end of the spring is attached to one end of said shaft.

8. Earphone according to the claim 6, wherein the return mechanism is designed as a bending spring, one end of which is attached to one end of the shaft and the other end is attached to the acoustic part of the earphone.

9. Earphone according to the claim 1, wherein a cylindrical hinge further comprises at least one sleeve in which said shaft is located.

10. Earphone according to the claim 1, wherein the mechanical part is arranged to rotate said shaft at an angle α in the range of 70 to 90 degrees in either direction from a position wherein said guide is oriented in the direction toward said sound opening.

11. Earphone according to the claim 10, wherein the earphone implemented to be worn in the either user's ear.

12. Earphone according to the claim 1, wherein at the section between places of fastening of the wire to the guide and to the acoustic transducer, said wire has additional slack to allow rotation of the shaft.

13. Earphone according to the claim 1, wherein the shaft and a resilient member are made hollow, wherein wire is placed inside the shaft and the resilient member and further mechanically fastened to the lower end of the shaft, forming a loop, and a portion of the wire between places of additional fastening of wire to the lower end of the shaft and to the electroacoustic transducer has an extra slack.

14. Earphone according to the claim 1, wherein said wire further comprises an electric socket on the section between the places of fastening to the upper part of the shaft and to the acoustic transducer.

15. Earphone according to the claim 1, wherein said shaft is arranged for longitudinal movement in said cylindrical hinge.

16. Earphone according to the claim 15, wherein the earphone further comprises a twisted cylindrical compression spring, which is wound around the shaft between the guide and acoustics part.

17. Earphone according to the claim 15, wherein part of said wire which is located between guide and acoustic part is implemented as a twisted cylindrical compression spring wound around the shaft.

18. Earphone according to the claim 1, wherein guide and said shaft are made hollow, wire positioned within said cavities, and a cylindrical hinge further comprises a brush-commutator assembly adapted to be able electrically connecting said wire with the electroacoustic transducer.

19. Earphone according to the claim 1, wherein the earphone further comprises an embouchure, where said acoustic part is further provided with fasteners for embouchure.

20. Earphone according to the claim 1, wherein the earphone further comprises a soft cover designed to fit over the acoustics portion of the earphone, wherein said soft cover has at least one opening serving for the sound output and located opposite said sound opening when wearing the cover.

21. Earphone according to the claim 1, wherein the resilient element is made detachable.

22. Earphone according to the claim 1, wherein the resilient element further comprising a longitudinal rigid thread, which is secured within the resilient member.

23. Earphone according to the claim 1, wherein a resilient element is made adapted to adjust the length.

24. Earphone according to the claim 1, wherein a resilient element is formed as a loop.

25. Earphone according to the claim 1, wherein the earphone further comprises at least one latch, adapted to hold the shaft, at least in one of said positions.

26. Earphone according to the claim 1, wherein the earphone further comprises at least one microphone.

27. Earphone according to the claim 26, wherein the earphone further comprises a bone conduction microphone.

28. In-the-ear earphone to be worn in two positions, comprising:
an acoustic part comprising at least one electroacoustic transducer and at least one sound opening designed to output an acoustic signal generated by the electroacoustic transducer,
a wire, electrically connected with said electroacoustic transducer,
the mechanical part, connected with said acoustic part through a cylindrical hinge and having
a shaft designed to be rotatable,
the resilient element, connected to one end of said shaft,
a guide for wire connected to the opposite end of said shaft, wherein, said resilient member and the guide are located at its greater part in the same plane with the axis of rotation of the shaft and oriented substantially in opposite directions from the axis of rotation of the shaft;
wherein said sound opening is located at the end of the acoustic part, opposing cylindrical hinge;
said end portion of acoustic part is designed in such a way as to exclude the possibility of clogging the sound opening when wearing in any of said positions;
said cylindrical hinge is designed in such a way to permit rotation of said shaft by an angle α, which is at least 70 degrees from the position wherein said guide is oriented towards the sound opening;
said wire is mechanically connected with said guide;
wherein, said guide has such a length that when worn in any of said two positions, said guide is placed at the top clipping of the auricle between leg curl and upper-tragus tubercle, wherein, the place of connection of the wire and said guide is located on the surface of the front ligament of the auricle, wherein the wire goes around the ear from the top;
said acoustic part is shaped so that when worn in one of said positions corresponding to the shaft rotation at an angle α 70÷90 degrees, said acoustic part at least partially housed within the user's outer auditory canal, wherein the sound outlet is recessed into the external auditory canal, wherein a resilient member is located in the cavity of the auricle behind anti-tragus and thus can serve to extract the earphone from the external auditory canal.

29. Earphone according to the claim 28, wherein, the earphone further comprises a protective grille designed for protection from clogging the sound opening while wearing.

30. Earphone according to the claim 28, wherein at least the one end of said shaft is curved about the axis of rotation.

31. Earphone according to the claim 30, wherein both ends of the shaft are bent in opposite directions from the axis of rotation.

32. Earphone according to the claim 28, wherein the earphone further comprises a return mechanism, which returning shaft to a position wherein the guide is oriented towards the sound opening and the angle alpha is close to or equal to 0.

33. Earphone according to the claim 32, wherein said return mechanism is designed as a cylindrical helical spring loosely wound around the shaft, wherein one end of the spring is attached to the acoustic portion and the other end of the spring is attached to one end of said shaft.

34. Earphone according to the claim 32, wherein the return mechanism is designed as a bending spring, one end of which is attached to one end of the shaft and the other end is attached to the acoustic part of the earphone.

35. Earphone according to the claim 28, wherein the earphone further comprises at least one latch, adapted to hold the shaft, at least in one of said positions.

36. Earphone according to the claim 28, wherein the mechanical part is arranged to rotate said shaft at an angle α in the range of 70 to 90 degrees in either direction from a position wherein said guide is oriented in the direction toward said sound opening.

37. Earphone according to the claim 36, wherein the earphone implemented to be worn in the either user's ear.

38. Earphone according to the claim 28, wherein at the section between places of fastening of the wire to the guide and to the acoustic transducer, said wire has additional slack to allow rotation of the shaft.

39. Earphone according to the claim 28, wherein shaft and resilient member are made hollow, wire is placed inside the shaft and the resilient member and further mechanically fastened to the lower end of the shaft, forming a loop, wherein the portion of wire between places of additional fastening of wire to the lower end of the shaft and to the electroacoustic transducer had an extra slack.

40. Earphone according to the claim 28, wherein said wire further comprises an electrical connector on the section between the fastening places to the upper part of the shaft and to the acoustic transducer.

41. Earphone according to the claim 28, wherein said shaft is adapted for longitudinal movement within said cylindrical hinge.

42. Earphone according to the claim 41, wherein earphone further comprises a cylindrical helical compression spring, which is wounded around the shaft between the guide and acoustic part.

43. Earphone according to the claim 41, wherein portion of said wire disposed between the guide and acoustic part is formed as a cylindrical helical compression spring wounded around the shaft.

44. Earphone according to the claim 28, wherein guide and said shaft are made hollow, wire positioned within said cavities, and a cylindrical hinge further comprises a brush-commutator assembly adapted to be able electrically connecting said wire with the electroacoustic transducer.

45. Earphone according to the claim 28, wherein earphone further comprises an embouchure, where said acoustic part is further provided with fasteners for embouchure.

46. Earphone according to the claim 28, wherein the earphone further comprises a soft cover designed to fit over the acoustics portion of the earphone, wherein said soft cover has at least one opening serving for the sound output and located opposite said sound opening when wearing the cover.

47. Earphone according to the claim 28, wherein the resilient element is made detachable.

48. Earphone according to the claim 28, wherein the resilient element further comprising a longitudinal rigid thread, which is secured within the resilient member.

49. Earphone according to the claim 28, wherein a resilient element is made adapted to adjust the length.

50. Earphone according to the claim 28, wherein a resilient element is formed as a loop.

51. Earphone according to the claim 28, wherein a cylindrical hinge further comprises at least one sleeve.

52. Earphone according to the claim 28, wherein the earphone further comprises at least one microphone.

53. Earphone according to the claim 52, wherein the earphone further comprises a bone conduction microphone.

54. A method of wearing the in-ear-canalphone comprising:
an acoustic part having at least one electro-acoustic transducer and at least one sound opening for the acoustic signal output, generated by electro-acoustic transducer,
a wire electrically coupled to said electro-acoustic transducer,
a mechanical portion connected to said acoustic part through a cylindrical hinge and comprising
a rotatable shaft,
a resilient member connected to one end of said shaft,
a guide wire connected to an opposite end of said shaft, wherein, said resilient member and the guide located at its large parts in one plane with the axis of rotation of shaft, and oriented essentially in opposite directions from the axis of rotation of shaft, wherein said sound opening is located at the end of acoustic part, opposing to cylindrical hinge, said end of acoustic part configured so as to prevent clogging of the sound outlet during wearing in any of said positions, said cylindrical hinge is formed so as to allow rotation of said shaft by an angle α, which is at least 70 degrees from a position wherein said guide is oriented towards the sound opening, and said wire is mechanically connected to said guide,
wherein, for arranging the sound opening inside of the external auditory canal, the user turns the shaft at an angle α, which is at least 70 degrees from a position wherein said guide is oriented towards the sound opening, arranges acoustic part inside of the external auditory openings, wherein a user places the resilient member in the cavity of the auricle behind anti-tragus;
for arranging the sound opening on the outside from the entrance of the external auditory canal, a user rotates the shaft to a position where the upper part of the shaft directed towards the acoustical opening, arranges acoustic part in the cavity of the auricle between the tragus and anti-tragus, and arranges a resilient member in the in the cavity of the auricle behind the anti-tragus;
wherein, when worn in any of said two positions, the user places said guide wire at the top clipping of the ear auricle between the leg curl and the upper-tragus tubercle, place of connection of wire and said guide on the surface of the front ligament of the auricle, and wire from the top of the auricle.
